(19) United States
(12) Patent Application Publication
(10) Pub. No.: US 2017/0076347 A1
(43) Pub. Date: Mar. 16, 2017

(54) INTERACTIVE GENERATION OF CUSTOMIZED ORDERABLE ARTICLES APPARATUS, METHODS, ARTICLES AND TOOLS

(71) Applicant: KNACK LLC, Seattle, WA (US)

(72) Inventors: Laura Jennings, Seattle, WA (US); Tammy Savage, Seattle, WA (US); Jason Kelly, Kirkland, WA (US)

(21) Appl. No.: 15/260,939

(22) Filed: Sep. 9, 2016

Related U.S. Application Data
(60) Provisional application No. 62/217,266, filed on Sep. 11, 2015.
(60) Provisional application No. 62/217,273, filed on Sep. 11, 2015.
(60) Provisional application No. 62/217,275, filed on Sep. 11, 2015.

(51) Int. Cl. G06Q 30/06; G06F 17/30

(52) U.S. Cl. CPC G06Q 30/0621; G06Q 30/0643; G06F 17/30867

(57) ABSTRACT

Articles (e.g., gift) can be created by one or more creators or participants using system supplied base or template articles, which define a container and a set of items to be held by the container. The articles, containers, and items are selectable from sets or pallets of such, which can be represented as tiles of a user interface, with user selectable icons or hyperlinks. The article can include customized tags, customized product label, and customized storybooks, including standard content and customized user specified content. Two or more creators can collaboration on an article, using various system supplied tools. Articles can be assembled and caused to be delivered to intend recipients via various fulfillment mechanisms.

### BACKGROUND

Technical Field

This disclosure generally relates to networked computing environments, and particularly to interactive systems and methods of ordering articles.

Description of the Related Art

There are a large variety of existing options for online ordering of articles. Most of these options employ a Website with Webpages via which an end user can browse available retail items, select one or more retail items for purchase, and place an order for the retail item(s). Many of these Websites allow end users to pre-populate certain information needed to place and fulfill an order, for instance user name, billing address, delivery address, and billing information, such as credit card number, credit card expiration date and credit card verification number. In some instances, a user can elect to split an order between two or more shipments, for instance where one retail item is back ordered or would otherwise delay delivery of other retail items.

Some of these Websites present suggestions to users based on a user's prior purchases, current purchase or browsing history. Such suggestions often prompt the user to add another retail item to a purchase transaction. Selected retail items are added to a list or virtual “shopping cart.” After selecting one or more items, the user completes the transaction, reviewing various Webpages to ensure the contents of the order are correct, the order information is correct, typically culminating in selection of a buy or similar user selectable icon.

Such online retail experiences essentially replicate the typical “bricks and mortar” retail shopping experience, with the added convenience being able to shop at any time from almost any location, and with the suggestion of retail items based on previous purchase or browsing history of the user and/or other users.

### BRIEF SUMMARY

Often an individual (i.e., buyer, sender) would like to purchase and send a gift to another individual (i.e., intended recipients). The buyer or sender can use an existing online Website to purchase and have a retail item delivered to the intended recipient. Often the Website will provide the ability to enclose a “personalized message” for delivery along with the item, in the form of a note or card. Yet, such a gift, even with a “personalized message” is often considered too impersonal.

Various implementations described herein allow a user to create a customized article. For example, the user personally selects a decorative container for the article, and a customized set of items that fit in the decorative container (e.g., re-useable glass jar or vessel). The user can select and/or customize a tag, customize a product label and/or portions of a customized storybook as part of the article or package. The customized article typically takes the form of a gift, which the user is personally creating to for an intended recipient. The user can then order the customized article, which a fulfillment entity or company assembles, places in disposable shipping packaging (e.g., cardboard box), and ships to the intended recipient.

Various implementations described herein allow a user to create an article from scratch, providing a maker stage and tools to select the container, the set of items to fit in the container, and to create the tag and storybook. Various implementations described herein allow a user select from a variety of previously created articles, to serve as a base or template which the user can modify to customize the article, or alternatively to order without modification.

Existing online retail options also fail to allow effective collaboration by two or more users or individuals. Various implementations described herein provide a shared maker stage and tools that facilitate collaboration between two or more users in custom creating an article (e.g., gift) to be sent to an intended recipient. The tools can, for example, allow two or more users to select various components of the article, and customization of the same. The tools can, for example, allow two or more users to share in paying the cost of the article. The tools can allow a user to selectively control a level of access, authority or permission of other users in collaborating on a given project to create a customized article.

A method of operation in a system to generate customized orderable articles, the system which includes at least one processor and at least one processor-readable medium communicatively coupled to the at least one processor, and at least one communications port that provides communications, may be summarized as including: for a first instance of a first article that comprises a first container and a first set of two or more items to be held by the first container, receiving, by the at least one processor, information that represents a selection indicative of a first item of the two or more items; comparing, by the at least one processor, an opening value indicative of a defined dimension of an opening in the first container to a value indicative of at least one defined outer dimension of the first item; determining, by the at least one processor, whether the first item will fit through the opening in the first container based on the comparison of the opening value and the at least one defined outer dimension of the first item; comparing, by the at least one processor, a capacity value indicative of a defined capacity of the first container with a value indicative of a defined volume of the first item; determining, by the at least one processor, whether the first item will fit in the first container based on the comparison of the capacity value indicative of the defined capacity of the first container with the value indicative of the defined volume of the first item; and causing at least one notification to be provided, via the at least one communications port, based on at least one of the determinations with respect to the first item.

The method may include: for the first instance of the first article, receiving, by the at least one processor, information that represents a selection indicative of a second item of the two or more items; comparing, by the at least one processor, the opening value indicative of the defined dimension of the opening in the first container to a value indicative of at least one defined outer dimension of the second item; determining, by the at least one processor, whether the second item will fit through the opening in the first container based on the comparison of the opening value and the at least one defined outer dimension of the second item; comparing, by the at least one processor, the capacity value indicative of the defined capacity of the first container with a value indicative of a cumulative volume of the first and the second items; determining, by the at least one processor, whether the second item will fit in the first container based on the comparison of the capacity value indicative of the defined capacity of the first container with the value indicative of the cumulative volume of the first and second items; and causing at least one notification to be provided via the at least one communications port based on at least one of the determinations with respect to the second item. The method may further include: for the first instance of the first article, receiving, by the at least one processor, information that represents a selection indicative of a third item of the two or more items; comparing, by the at least one processor, the opening value indicative of the defined dimension of the opening in the first container to a value indicative of at least one defined outer dimension of the third item; determining, by the at least one processor, whether the third item will fit through the opening in the first container based on the comparison of the opening value and the at least one defined outer dimension of the third; comparing, by the at least one processor, the capacity value indicative of the defined capacity of the first container with a value indicative of a cumulative volume of the first, the second, and the third items; determining, by the at least one processor, whether the second item will fit in the first container based on the comparison of the capacity value indicative of the defined capacity of the first container with the value indicative of the cumulative volume of the first, the second, and the third items; and causing at least one notification to be provided via the at least one communications port based on at least one of the determinations with respect to the third item. 4. The method of claim 2 wherein comparing the capacity value indicative of the defined capacity of the first container with a value indicative of a cumulative volume of the first and the second items includes comparing a total number of items defined as being holdable by the container to a total number of items in the set of at least two items, and wherein determining whether the second item will fit in the first container based on the comparison of the capacity value indicative of the defined capacity of the first container with the value indicative of the cumulative volume of the first and second items includes determining whether the total number of items in the set of at least two items is not greater than the total number of items defined as being holdable by the container. Comparing the capacity value indicative of the defined capacity of the first container with a value indicative of a cumulative volume of the first and the second items may include comparing a total defined sub-volumes defined as being holdable by the container to a total number of items in the set of at least two items, and wherein determining whether the second item will fit in the first container based on the comparison of the capacity value indicative of the defined capacity of the first container with the value indicative of the cumulative volume of the first and second items may include determining whether the total number of items in the set of at least two items is not greater than the total number of sub-volumes defined as being holdable by the container. Comparing the capacity value indicative of the defined capacity of the first container with a value indicative of a cumulative volume of the first and the second items may include: determining a cumulative volume of the items in the set of at least two items, and comparing a volume of the container to the determined cumulative volume of the items in the set of at least two items, and wherein determining whether the second item will fit in the first container includes determining whether the cumulative volume of the items in the set of at least two items is not greater than the volume of the container. Causing at least one notification to be provided based on at least one of the determinations with respect to the second item may include providing a notification that indicates that the second item is too large to fit through the opening of the first container in response to determining that the second item will not fit through the opening in the first container. Causing at least one notification to be provided based on at least one of the determinations with respect to the second item may include providing a notification that indicates that the second item is too large to fit within the first container in response to determining that the cumulative volume of the first and second items is greater than the capacity value indicative of the defined capacity of the first container. Causing at least one notification to be provided based on at least one of the determinations with respect to the first item may include providing a notification that indicates that the first item fits in the first container in response to determining that the cumulative volume of the first and second items is not greater than the capacity value indicative of the defined capacity of the first container. The method may further include: in response to determining that the second item will not fit through the opening in the first container, causing a prompt to be provided to select an alternative to the second item. The method may further include: in response to determining that the second item will not fit through the opening in the first container, causing a prompt to be provided to select an alternative to the first container. The method may further include: in response to determining that the second item will not fit through the opening in the first container, searching for a larger container that is of a same type as the first container; and causing a prompting of the user with a result from the searching. The method may further include: in response to determining that the second item will not fit in the first container, causing a prompt to be provided to select an alternative to the second item. The method may further include: in response to determining that the second item will not fit through the opening in the first container, searching, by the at least one processor, for a plurality of alternative items, to the second item, that will fit through the opening in the first container and that will fit in the first container along with the first item; and causing a prompt with the plurality of alternative items to be provided to select one of the alternative items from the plurality of alternative items. Searching for a plurality of alternative items to the second item may include: determining at least one category in which the second item is classified or at least one key term associated with the second item, and identifying the alternative items that are classified in the at least category that is the same as the at least one category in which the second item is classified or that has at least one key term in common. The method may further include: in response to determining that the second item will not fit in the first container, causing a prompt to be provided to select an alternative to the first container. The method may further include: in response to determining that the second item will not fit in the first container, searching for a larger container that is of a same type as the first container. The method may further include: in response to determining that the second item will not fit in the first container, searching, by the at least one processor, for a plurality of alternative items, to the second item, that will fit through the opening in the first container and that will fit in the first container along with the first item; and causing a prompt with the plurality of alternative items to be provided to select one of the alternative items from the plurality of alternative items. Searching for a plurality of alternative items to the second item may include: determining at least one category in which the second item is classified or at least one key term associated with the second item, and identifying the alternative items that are classified in the at least category that is the same as the at least one category in which the second item is classified or that has at least one key term in common. Comparing the opening value indicative of the defined dimension of the opening in the first container to a value indicative of at least one defined outer dimension of the first item may include comparing at least one of: i) a radius of the opening in the first container to a width of the first item; or ii) an area of the opening in the first container to an area encompassed by a perimeter of the first item. Causing at least one notification to be provided based on at least one of the determinations with respect to the first item may include providing a notification that indicates that the first item is too large to fit through the opening of the first container in response to determining that the first item will not fit through the opening in the first container. Causing at least one notification to be provided based on at least one of the determinations with respect to the first item may include providing a notification that indicates that the first item is too large to fit within the first container in response to determining that the first item will not fit in the first container. Causing at least one notification to be provided based on at least one of the determinations with respect to the first item may include providing a notification that indicates that the first item fits in the first container in response to determining both i) that the first item will fit through the opening in the first container, and ii) that the first item will fit in the first container.

A system to generate customized orderable articles may be summarized as including: at least one processor; at least one communications port that provides communications between the customized article generation system and a plurality of remotely located devices; at least one processor-readable medium communicatively coupled to the at least one processor, and which stores at least one of processor-readable instructions or data, which when executed by the at least one processor, cause the at least one processor to: for a first instance of a first article that comprises a first container and a first set of two or more items held by the first container, receive information that represents a selection indicative of a first item of the two or more items; compare an opening value indicative of a defined dimension of an opening in the first container to a value indicative of at least one defined outer dimension of the first item; determine whether the first item will fit through the opening in the first container based on the comparison of the opening value and the at least one defined outer dimension of the first item; compare a capacity value indicative of a defined capacity of the first container with a value indicative of a defined volume of the first item; determine whether the first item will fit in the first container based on the comparison of the capacity value indicative of the defined capacity of the first container with the value indicative of the defined volume of the first item; and cause at least one notification to be provided based on at least one of the determinations with respect to the first item.

The at least one of processor-readable instructions or data, when executed by the at least one processor, may further cause the at least one processor to: for the first instance of the first article, receive information that represents a selection indicative of a second item of the two or more items; compare the opening value indicative of the defined dimension of the opening in the first container to a value indicative of at least one defined outer dimension of the second item; determine whether the second item will fit through the opening in the first container based on the comparison of the opening value and the at least one defined outer dimension of the second item; compare the capacity value indicative of the defined capacity of the first container with a value indicative of a cumulative volume of the first and the second items; determine whether the second item will fit in the first container based on the comparison of the capacity value indicative of the defined capacity of the first container with the value indicative of the cumulative volume of the first and second items; and cause at least one notification to be provided based on at least one of the determinations with respect to the second item. The at least one of processor-readable instructions or data, when executed by the at least one processor, may further cause the at least one processor to: for the first instance of the first article, receive information that represents a selection indicative of a third item of the two or more items; compare the opening value indicative of the defined dimension of the opening in the first container to a value indicative of at least one defined outer dimension of the third item; determine whether the third item will fit through the opening in the first container based on the comparison of the opening value and the at least one defined outer dimension of the third; compare the capacity value indicative of the defined capacity of the first container with a value indicative of a cumulative volume of the first, the second, and the third items; determine whether the second item will fit in the first container based on the comparison of the capacity value indicative of the defined capacity of the first container with the value indicative of the cumulative volume of the first, the second, and the third items; and cause at least one notification to be provided based on at least one of the determinations with respect to the third item. To compare the capacity value indicative of the defined capacity of the first container with a value indicative of a cumulative volume of the first and the second items the at least one processor may compare a total number of items defined as being holdable by the container to a total number of items in the set of at least two items, and to determine whether the second item will fit in the first container based on the comparison of the capacity value indicative of the defined capacity of the first container with the value indicative of the cumulative volume of the first and second items the at least one processor may determine whether the total number of items in the set of at least two items is not greater than the total number of items defined as being holdable by the container. To compare the capacity value indicative of the defined capacity of the first container with a value indicative of a cumulative volume of the first and the second items the at least one processor may compare a total defined sub-volumes defined as being holdable by the container to a total number of items in the set of at least two items. To compare the capacity value indicative of the defined capacity of the first container with a value indicative of a cumulative volume of the first and the second items the at least one processor: may determine a cumulative volume of the items in the set of at least two items, and may compare a volume of the container to the determined cumulative volume of the items in the set of at least two items. To cause at least one notification to be provided based on at least one of the determinations with respect to the second item the at least one processor may cause a notification to be provided that indicates that the second item is too large to fit through the opening of the first container in response to determining that the second item will not fit through the opening in the first container. To cause at least one notification to be provided based on at least one of the determinations with respect to the second item the at least one processor may cause a notification to be provided that indicates that the second item is too large to fit within the first container in response to determining that the cumulative volume of the first and second items is greater than the capacity value indicative of the defined capacity of the first container. To cause at least one notification to be provided based on at least one of the determinations with respect to the first item that at least one processor may cause a notification to be provided that indicates that the first item fits in the first container in response to determining that the cumulative volume of the first and second items is not greater than the capacity value indicative of the defined capacity of the first container. The at least one of processor-readable instructions or data, when executed by the at least one processor, may further cause the at least one processor to: in response to determining that the second item will not fit through the opening in the first container, cause a prompt to be provided to select an alternative to the second item. The at least one of processor-readable instructions or data, when executed by the at least one processor, may further cause the at least one processor to: in response to determining that the second item will not fit through the opening in the first container, search for a larger container that is of a same type as the first container; and cause a prompt to the user with a result from the search. In response to determining that the second item will not fit in the first container, the at least one processor may cause a prompt to be provided to select an alternative to the second item. The at least one of processor-readable instructions or data, when executed by the at least one processor, may further cause the at least one processor to: in response to determining that the second item will not fit through the opening in the first container, search for a plurality of alternative items, to the second item, that will fit through the opening in the first container and that will fit in the first container along with the first item; and cause a prompt with the plurality of alternative items to be provided to select one of the alternative items from the plurality of alternative items. The at least one of processor-readable instructions or data, when executed by the at least one processor, may further cause the at least one processor to: determine at least one category in which the second item is classified or at least one key term associated with the second item, and identify the alternative items that are classified in the at least category that is the same as the at least one category in which the second item is classified or that has at least one key term in common. The at least one of processor-readable instructions or data, when executed by the at least one processor, may further cause the at least one processor to: in response to determining that the second item will not fit in the first container, causing a prompt to be provided to select an alternative to the first container. The at least one of processor-readable instructions or data, when executed by the at least one processor, may further cause the at least one processor to: in response to determining that the second item will not fit in the first container, searching for a larger container that is of a same type as the first container. The at least one of processor-readable instructions or data, when executed by the at least one processor, may further cause the at least one processor to: in response to determining that the second item will not fit in the first container, searching for a plurality of alternative items, to the second item, that will fit through the opening in the first container and that will fit in the first container along with the first item; and cause a prompt with the plurality of alternative items to be provided to select one of the alternative items from the plurality of alternative items.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn, are not necessarily intended to convey any information regarding the actual shape of the particular elements, and have been solely selected for ease of recognition in the drawings.

FIG. 1 is a schematic diagram of a networked environment including a number of servers, a number of clients communicatively coupled to the servers by one or more networks, according to one illustrated embodiment.

FIG. 2 is a schematic diagram of a subject based communication facilitation system including a subject based communication facilitation server computing system and a database stored on computer-readable media, according to one illustrated embodiment.

FIGS. 3A-3S are screens prints of respective Webpages, according to one illustrated embodiment.

FIG. 4 is a high level flow diagram showing a method of operation in a system to generate customized orderable articles from user selected containers and items, according to one illustrated embodiment.

FIG. 5 is a low level flow diagram showing a method of operation in a system to generate customized orderable articles, according to one illustrated embodiment, in which an ability of a selected item to fit through an opening and within a selected container is assessed and notification provided.

FIG. 6 is a low level flow diagram showing a method of operation in a system to generate customized orderable articles, according to another illustrated embodiment, in which a customized storybook is created as a part of the article to accompany the container and items.

FIG. 7 is a low flow diagram showing a method of operation in a system to generate customized orderable articles, according to one illustrated embodiment, in which a customized storybook is generated and assembled.

FIG. 8 is a low flow diagram showing a method of operation in a system to generate customized orderable articles, according to yet another illustrated embodiment, in which a customized tag is generated as a part of the article to accompany the container and items.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks and other communications channels have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

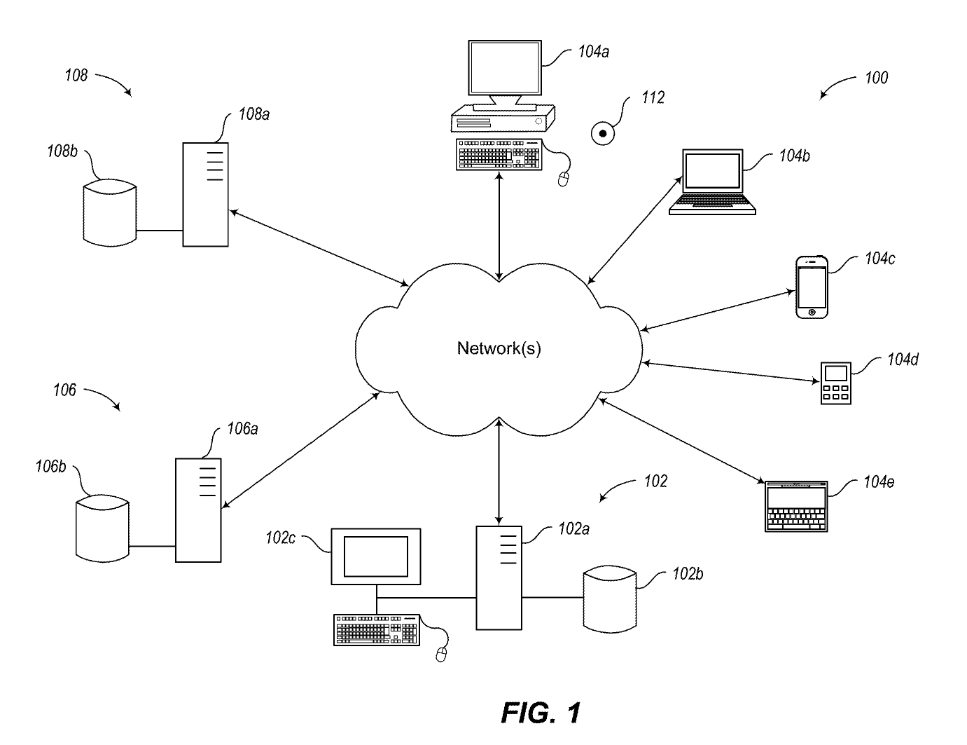

FIG. 1 shows a network environment 100 in which various implementations of the presently described apparatus, methods and articles can reside, according to one illustrated embodiment.

The network environment 100 includes one or more article customization server computing systems 102 that allows users to generate or create and/or order customized articles. The article customization server computing system(s) 102 provides a Web portal, Website or Web services accessible by users via one or more user client devices 104a-104e (collectively 104). The network environment 100 can optionally include one or more intermediary electronic commerce (ecommerce) server computing systems 106, which provides ecommerce services, for example, virtual storefront, payment processing, order tracking and/or order fulfillment services. The network environment 100 can optionally include one or more vendor computing systems 108 (only one shown), which provide information and allows ordering of components for the customized or customizable articles. One or more communications infrastructures, represented by networks 110, provide communications between the article customization server computing system(s) 102 and the user client devices 104, and optionally between the article customization server computing system(s) 102 and the intermediary electronic commerce server 108, and/or vendor computing system(s) 110.

The one or more communications networks 110 may take a variety of forms. For instance, the communications networks 110 may include wired, wireless, optical, or a combination of wired, wireless and/or optical communications links. The one or more communications networks 110 may include public networks, private networks, unsecured networks, secured networks or combinations thereof. The one or more communications networks 110 may employ any one or more communications protocols, for example, TCP/IP protocol, UDP protocols, IEEE 802.11 protocol, as well as other telecommunications or computer networking protocols. The one or more communications networks 110 may include what are traditionally referred to as computing networks and/or what are traditionally referred to as telecommunication networks or combinations thereof. In at least one implementation, the one or more communications networks 110 includes the Internet, and in particular, the Worldwide Web or (referred to herein as “the Web”). Consequently, in at least one implementation, one or more of the article customization server computing system(s) 102 execute server software to serve HTML source files or Web pages and/or Web services, and one or more user client devices 104 execute browser software to request and display HTML source files or Web pages. Notably, the network 110 does not form part of any claimed environment or system, and is typically supplied by a third party entity, for example, a telecommunications company, Internet service provider (ISP) or other entity.

The user client devices 104 can take any of a large variety of forms, a few of which are illustrated in FIG. 1. The user client devices 104 can, for example, take the form of one or more computers or computing systems, such as desktop or personal computers (PCs) 104a or laptop or netbook computers 104b, with nontransitory computer-readable media 112. The user client devices 104 can, for example, take the form of one or more mobile or telecommunications devices, for instance Internet or Web enabled cellular or “smart” phones 104c (only one illustrated), or personal digital assistant (PDA) devices 104d (only one illustrated) or tablet computers 104e. The user client devices 104 can store and execute a set of browser instructions or program. The user client devices 104 can be communicatively coupled to the network 110 via wired, wireless or a combination of wired and wireless communications channels.

The vendor computing system(s) 108 can take a large variety of forms. The vendor computing system(s) 108 can, for example, take the form of one or more mainframe computer systems, mini-computer systems, workstation computer systems, personal computer systems, and/or server computer systems. The vendor computing system(s) 108 can, for example, include a computer system 108a with one or more processors (i.e., hardware circuitry) and nontransitory computer- or processor-readable media 108b that stores at least one of processor-executable instructions and/or data. For example, the vendor computing system(s) 108 can include one or more processors that execute server instructions (i.e., server software) stored on the computer-readable media 108b to provide server functions in the network environment 100. For instance, the vendor computing system(s) 108 can serve files related to items sold or distributed by the vendor, which files are stored in one or more databases or other computer-readable storage media 108b. Also for instance, the vendor computing system(s) 108 can implement electronic invoicing and/or payment for ordered items. Typically, the vendor computing system(s) 108 interacts with the article customization server computing systems 102 or the intermediary ecommerce server computing system(s) 106, for example, to update an inventory of available components (e.g., decorative containers, items to be placed in decorative containers) and/or to order components or inventory to be sent to a fulfillment facility. Typically, the vendor computing system(s) 108 does not interact with user client devices 104.

The intermediary ecommerce server computing system(s) 106 can take a large variety of forms. The intermediary ecommerce server computing system(s) 106 can, for example, take the form of one or more mainframe computer systems, mini-computer systems, workstation computer systems, personal computer systems, and/or server computer systems. The intermediary ecommerce server computing system(s) 106 can, for example, include a computer system 106a with one or more processors (i.e., hardware circuitry) and nontransitory computer- or processor-readable media 106b that stores at least one of processor-executable instructions and/or data. For example, the intermediary ecommerce server computing system(s) 106 can include one or more processors that execute server instructions (i.e., server software) stored on the computer-readable media 106b to provide ecommerce server functions in the network environment 100, preferably in a scalable model. For instance, the server computing system(s) 106 can provide a virtual storefront, which can be customizable, and serve files related to the virtual storefront, which files are stored in one or more databases or other computer-readable storage media 106b, or obtainable from the article customization server computing systems 102. Also for instance, the server computing system(s) 106 can provide payment processing, order tracking and/or order fulfillment services,

The intermediary ecommerce server computing system(s) 106 can be operated by a third party entity, separate from the users and the operator of the article customization server computing systems 102. For example, ecommerce services can be provided via SHOPIFY® Web services supplied by SHOPIFY Inc., Amazon Webstore® supplied by AMAZON.COM, or via other ecommerce services providers such as Volusion, osCommerce, Magneto, WordPress, Prestashop SA, Yahoo® Stores, Bigcartel, LLC, GoDaddy, Hostgator.com, Joomla!® supplied by Open Source Matters, Inc., 3dCart, Drupal Ecommerce, 1&1, and Zencart to name a few.

The Website or Web services can be implemented as an application proxy on the intermediary ecommerce server computing system(s) 106, while the actual code is hosted on the first party's own systems (i.e., article customization server computing system(s) 102). In particular, application proxy functionality of the intermediary ecommerce server computing system(s) 106 can be configured to read the HTML/CSS files from the article customization server computing system(s) 102.

This approach advantageously takes advantage of existing ecommerce functionality provided by the intermediary ecommerce server computing system(s) 106, while still allowing customized functionality to be provided via article customization server computing system(s) 102. Of course, such an approach is optional, and in some implementations the article customization server computing system(s) 102 can directly provide the Web services, Website or Web portal and associated functionality.

The article customization server computing system(s) 102 may include one or more article customization servers 102a, nontransitory computer- or processor-readable media 102b that stores at least one of processor-executable instructions or data (e.g., files, HTML, CSS, user information, product information, shipment information, browsing history, article creation history, collaboration group information), and optionally one or more control terminals 102c. The one or more control terminals may provide a user interface to interact with and control operation of the one or more article customization server computing system(s) 102 and/or nontransitory computer- or processor-readable media 102b.

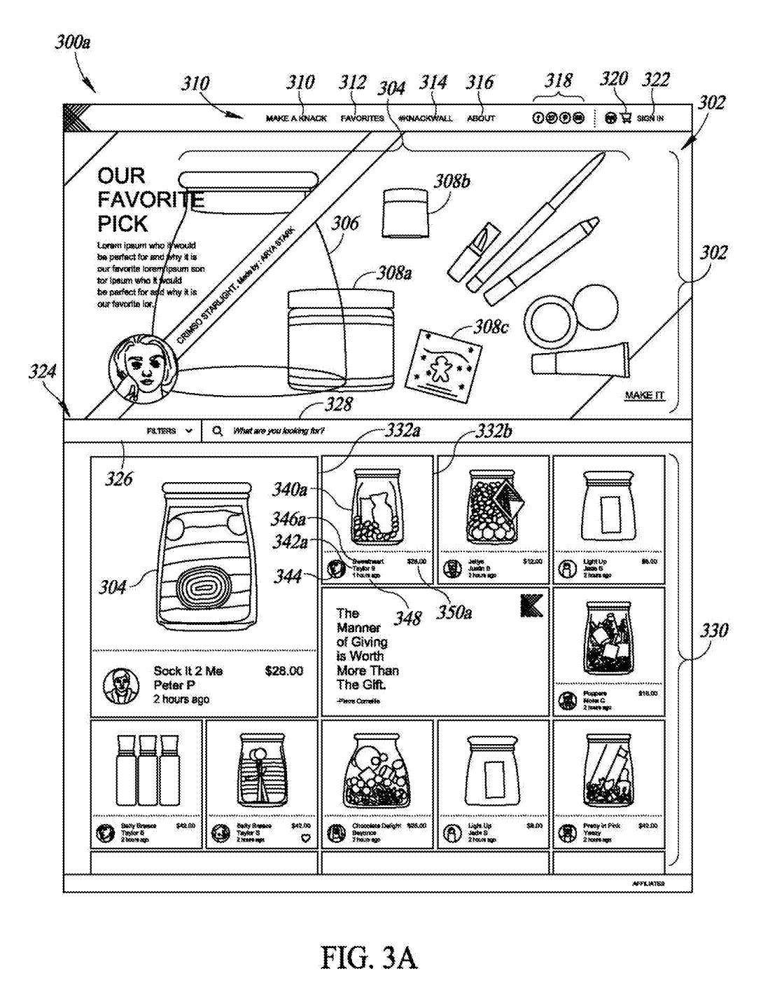

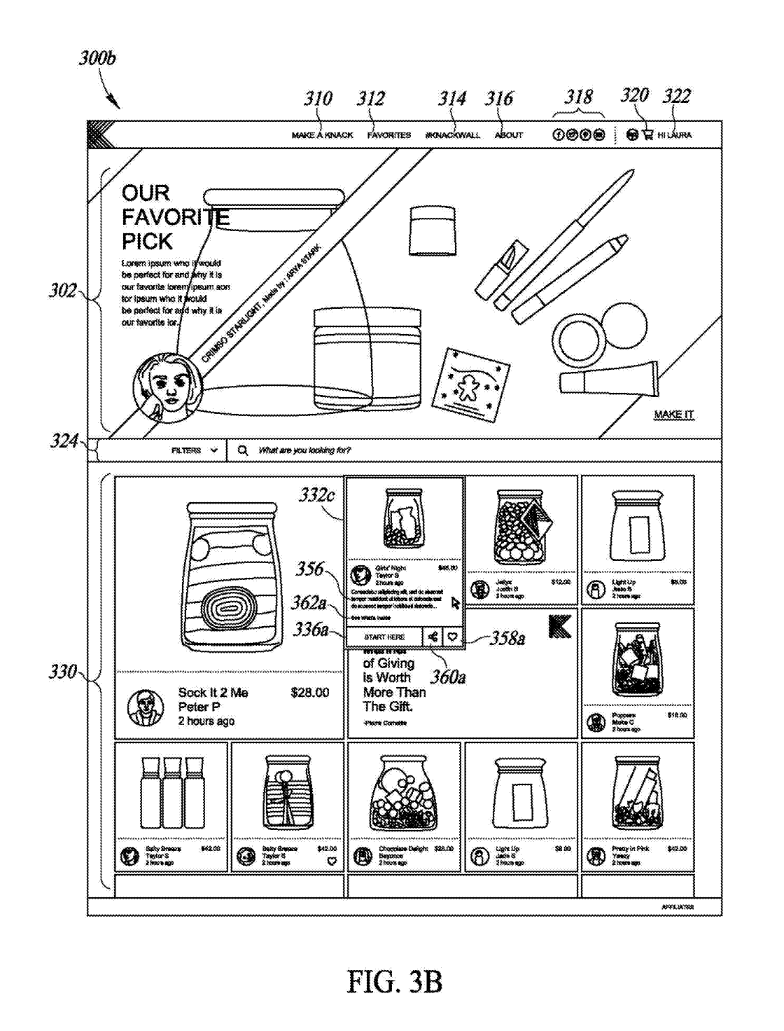

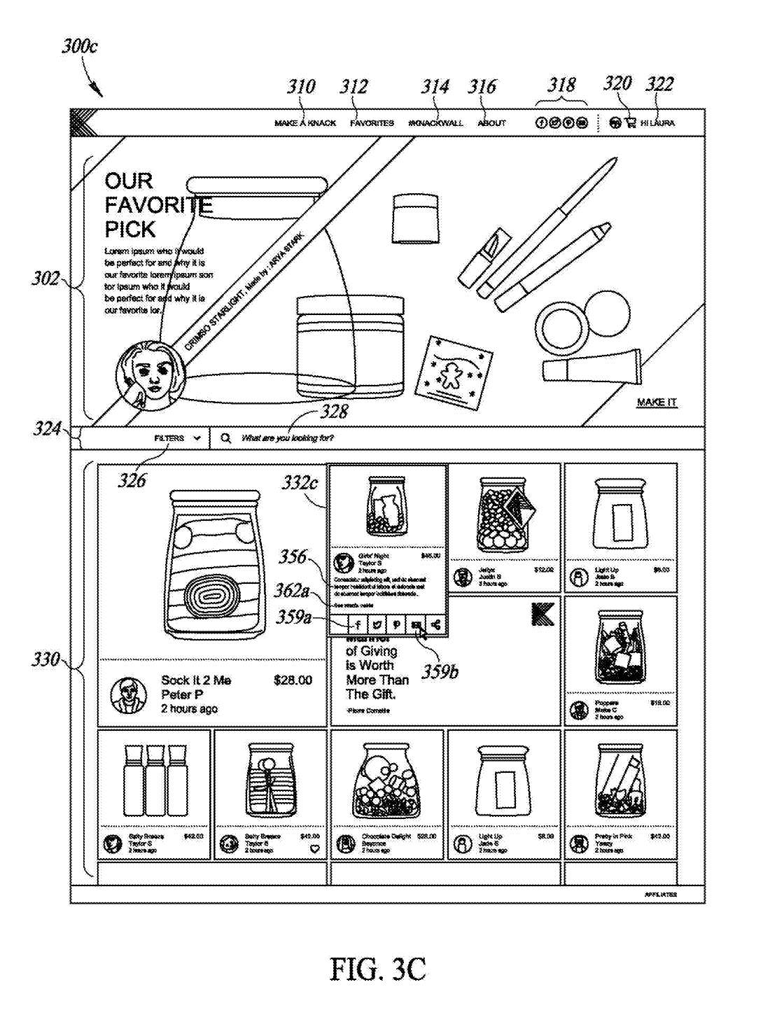

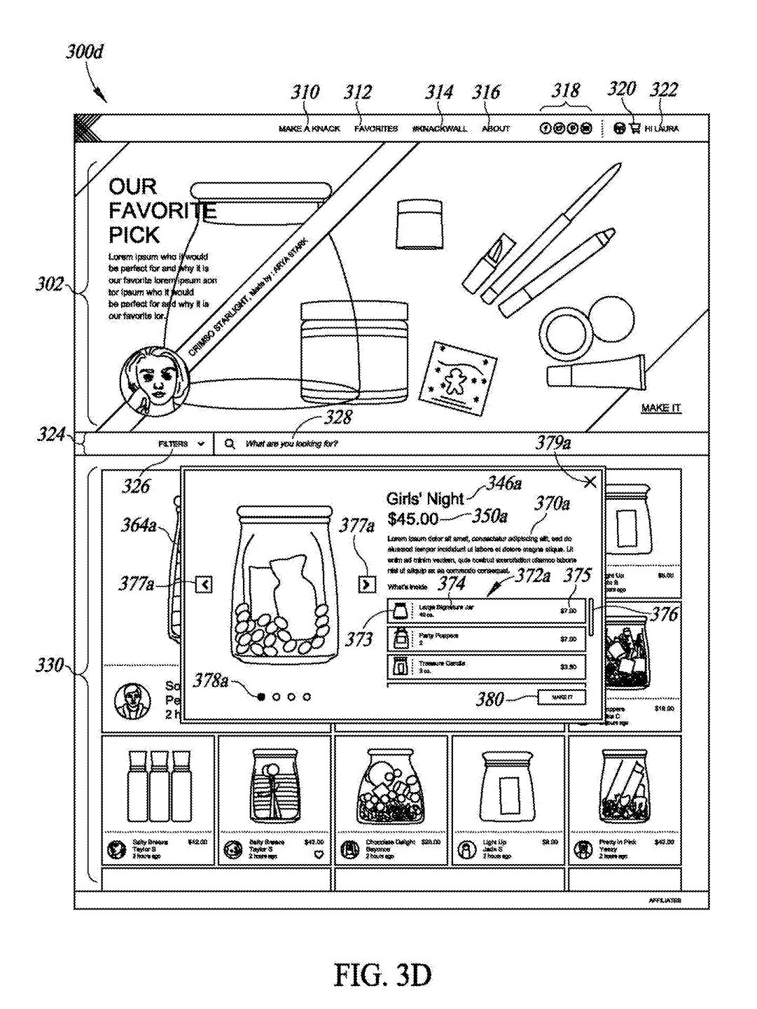

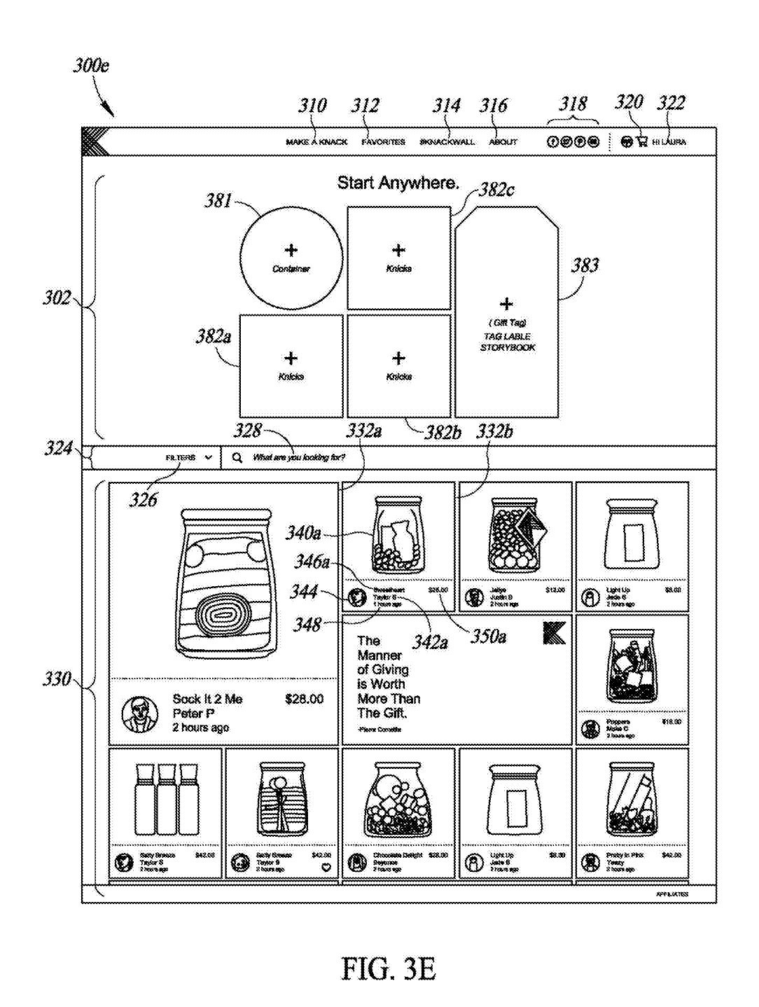

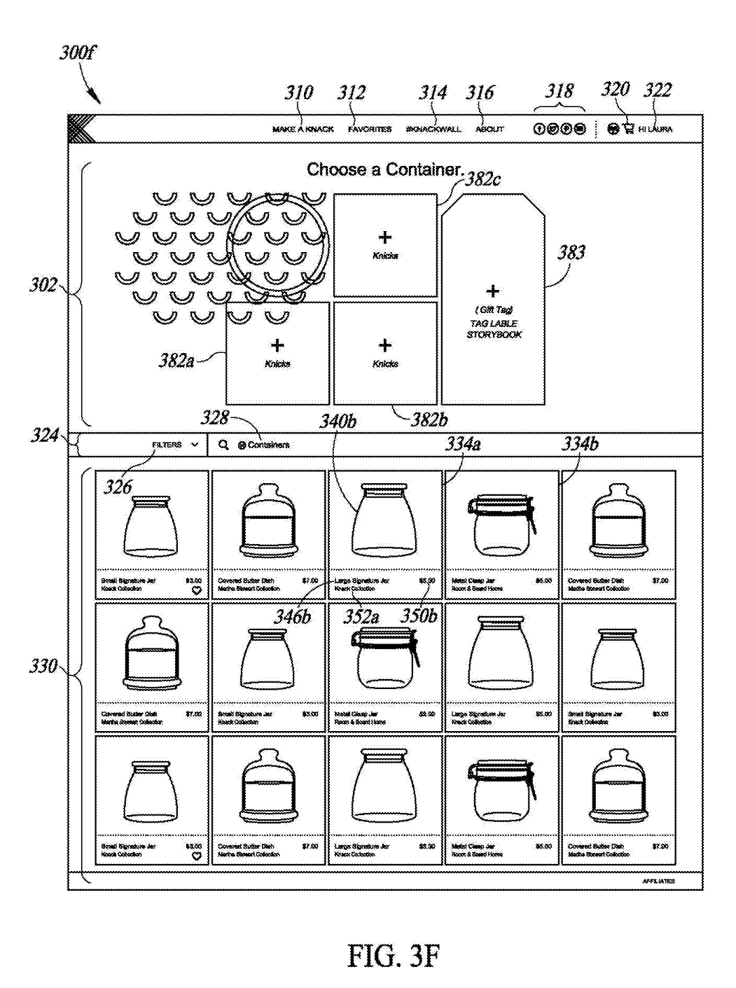

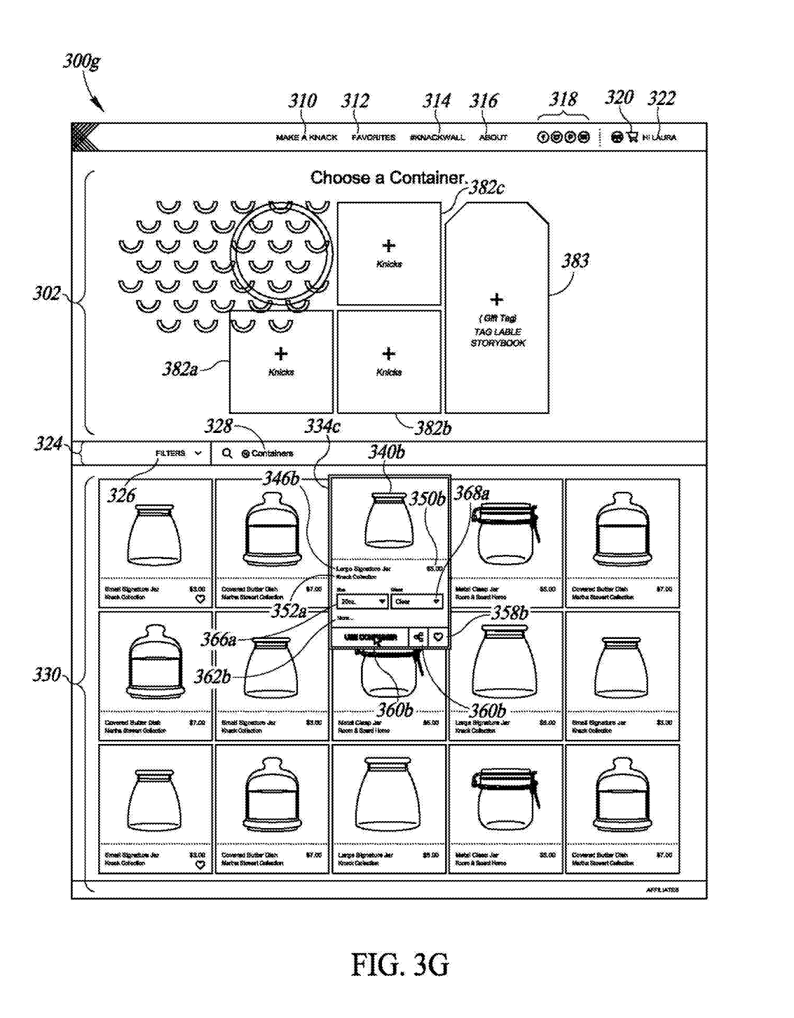

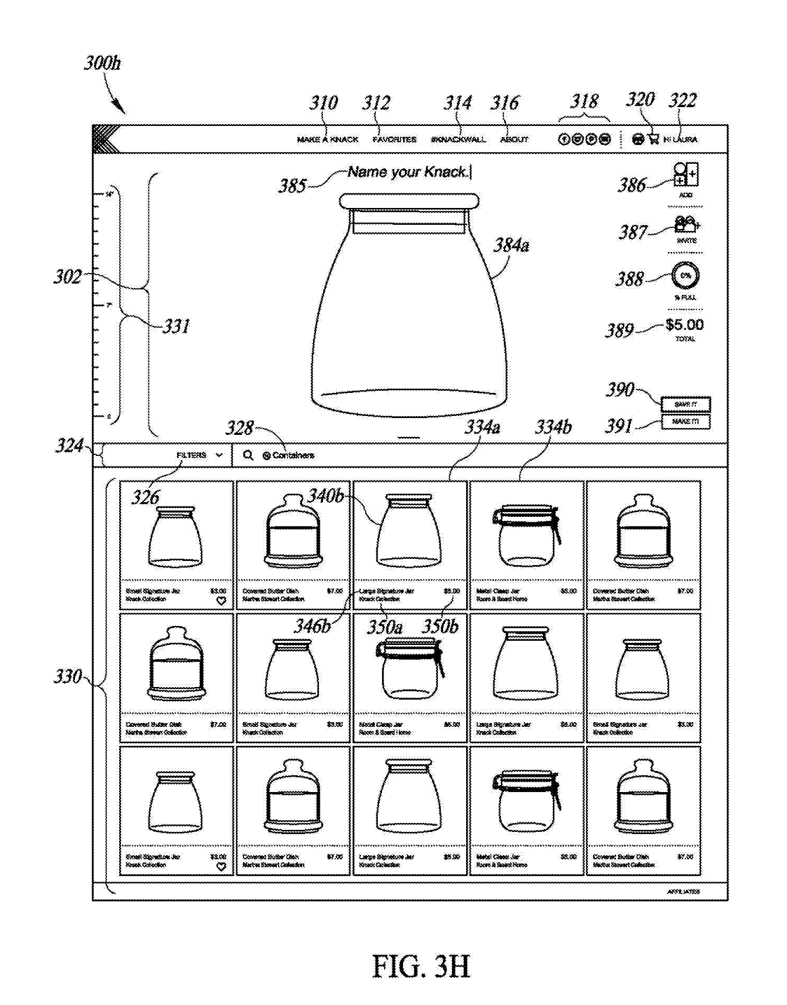

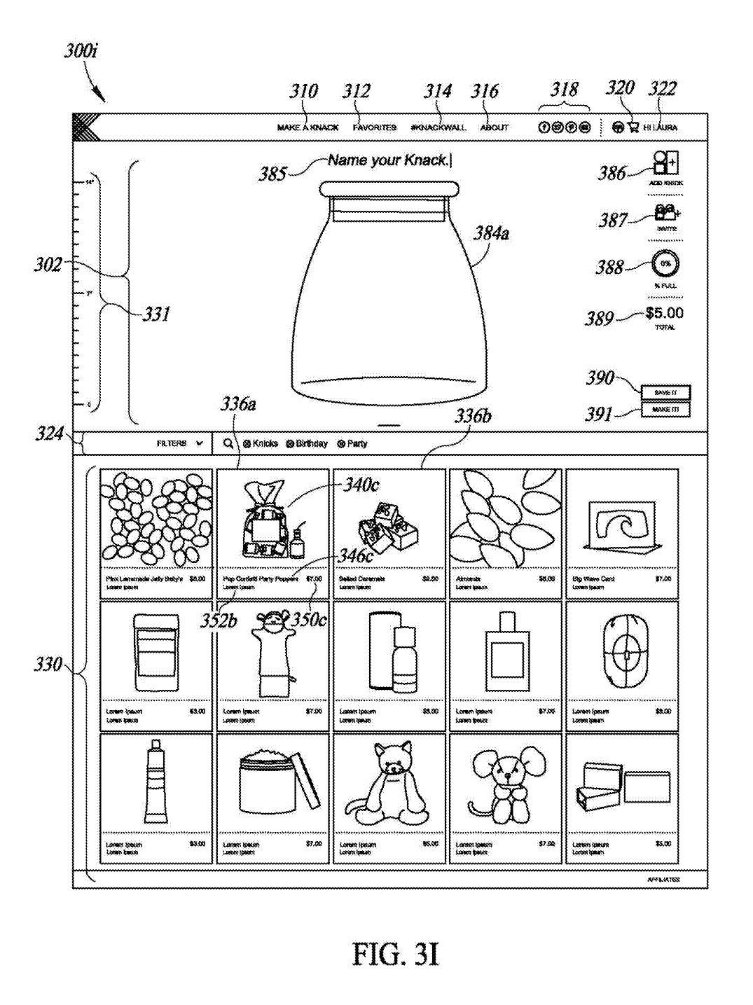

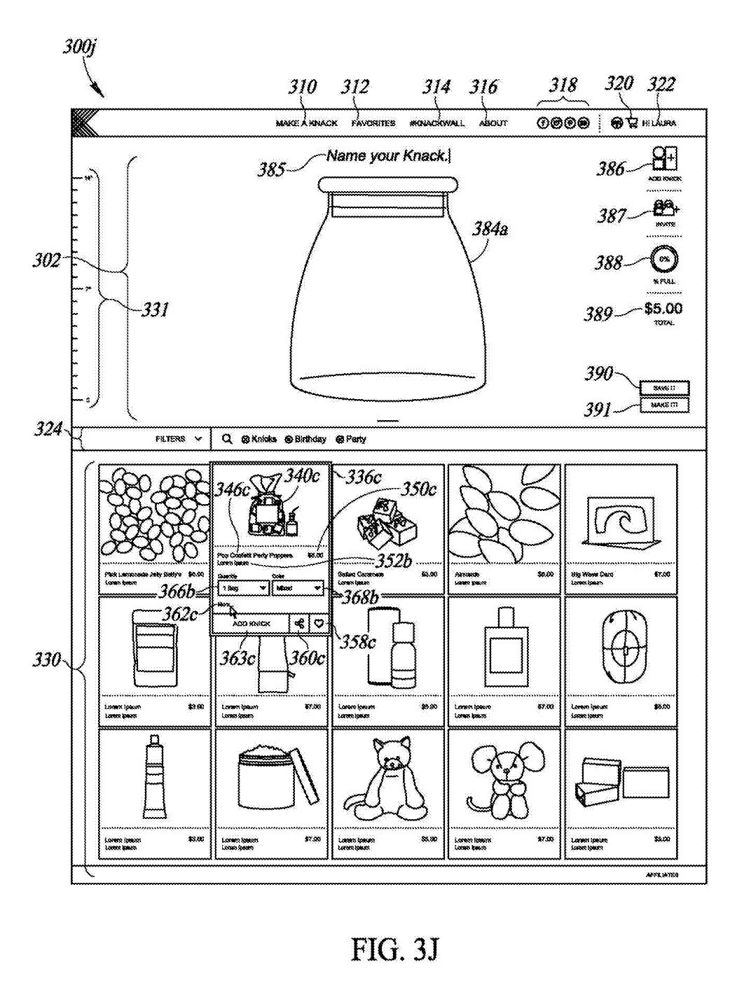

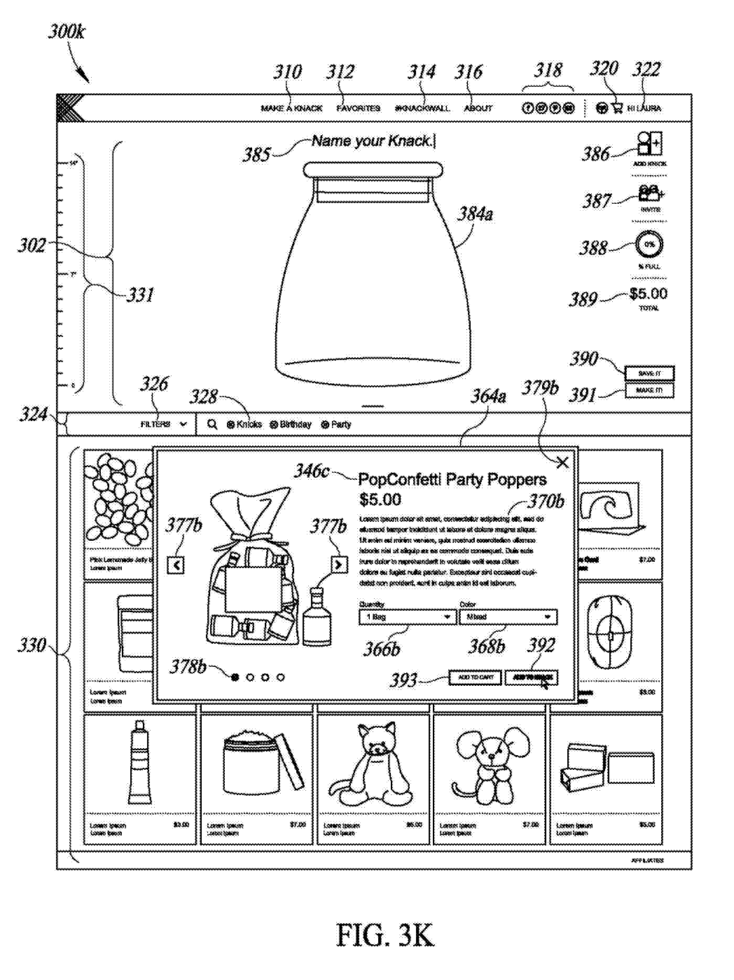

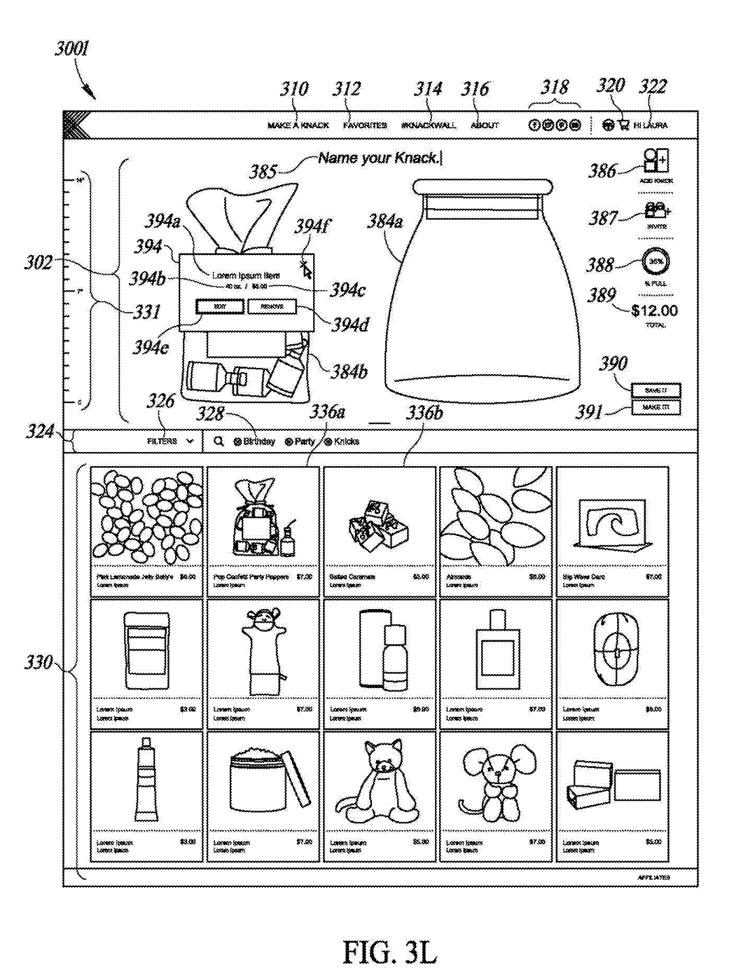

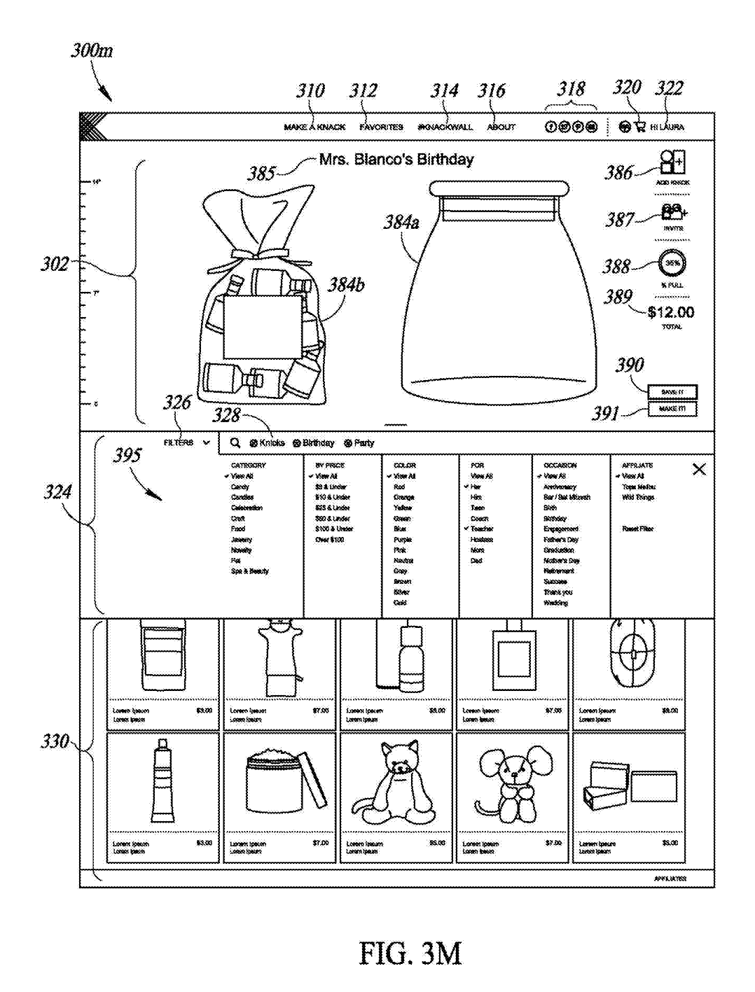

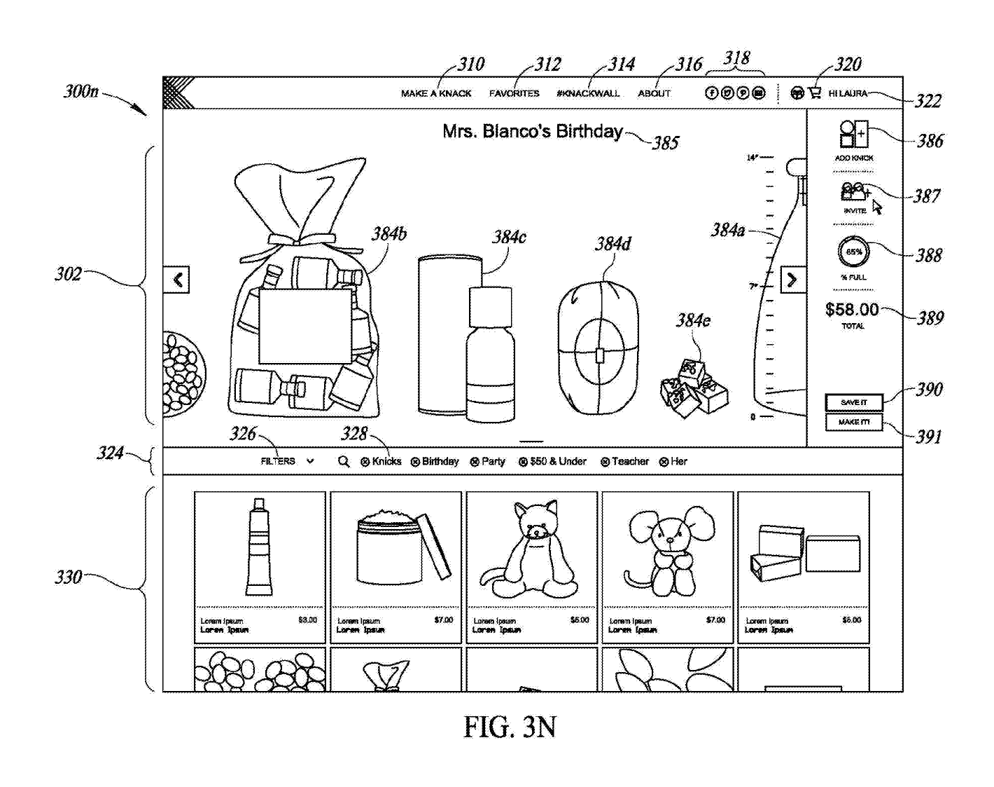

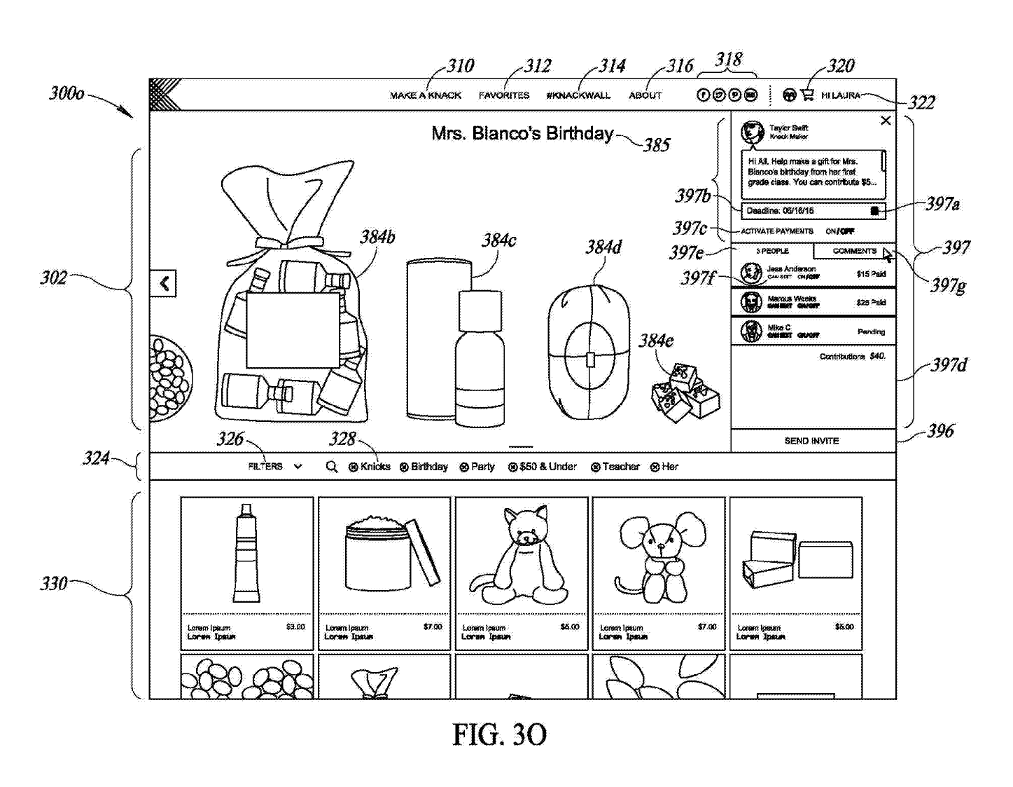

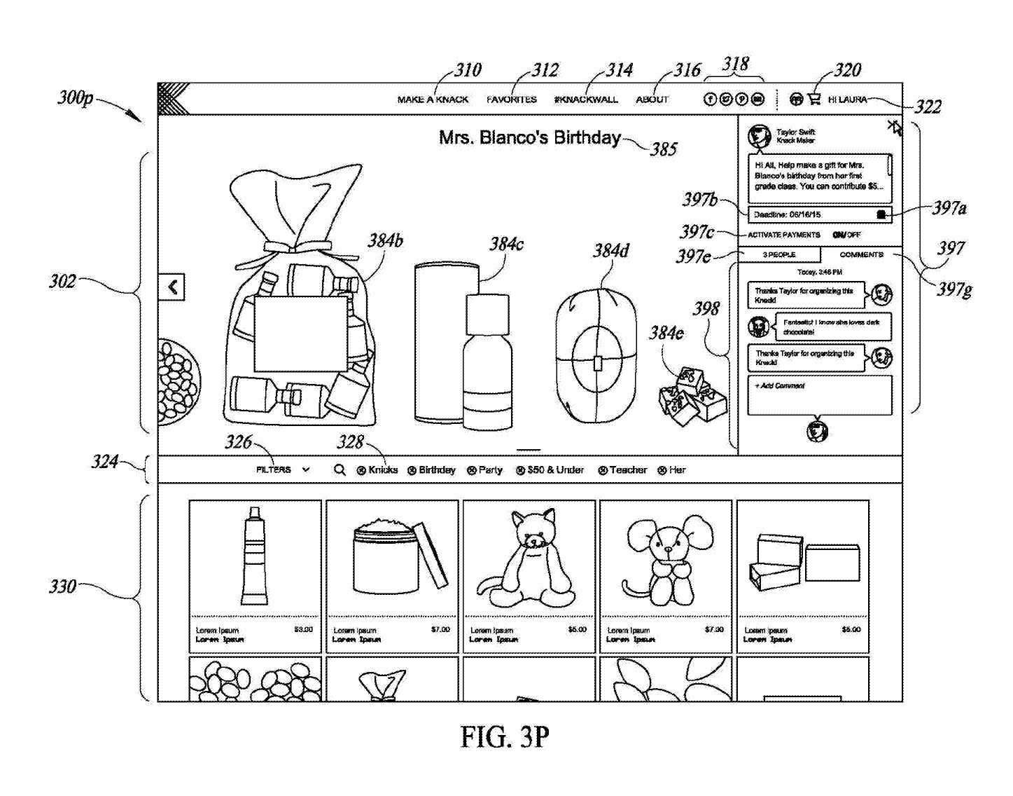

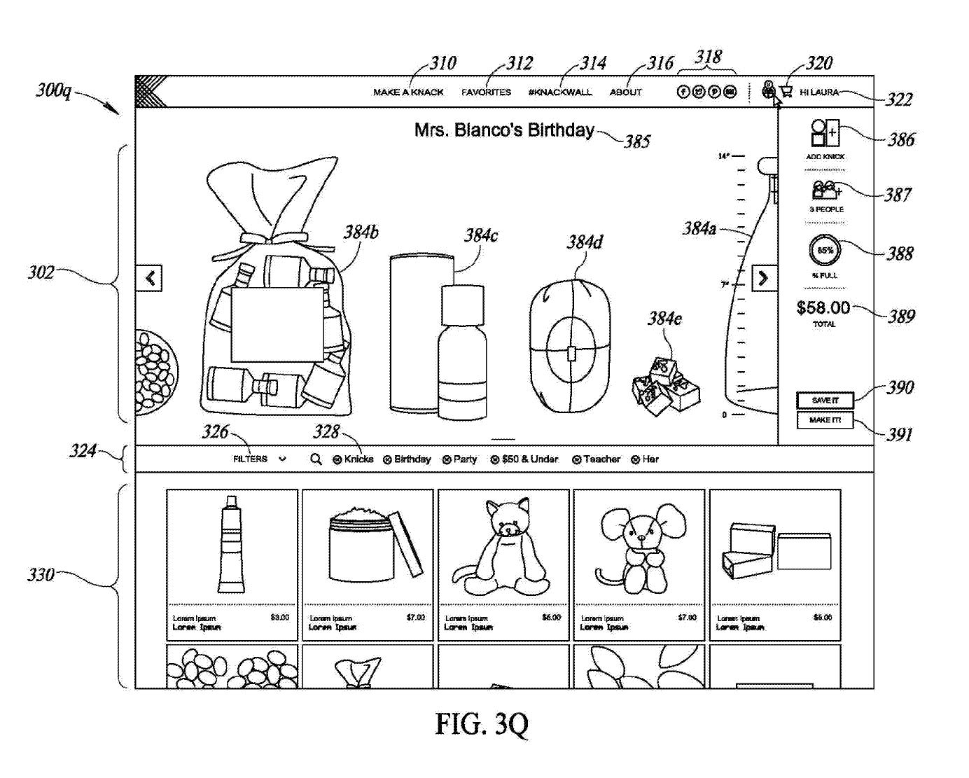

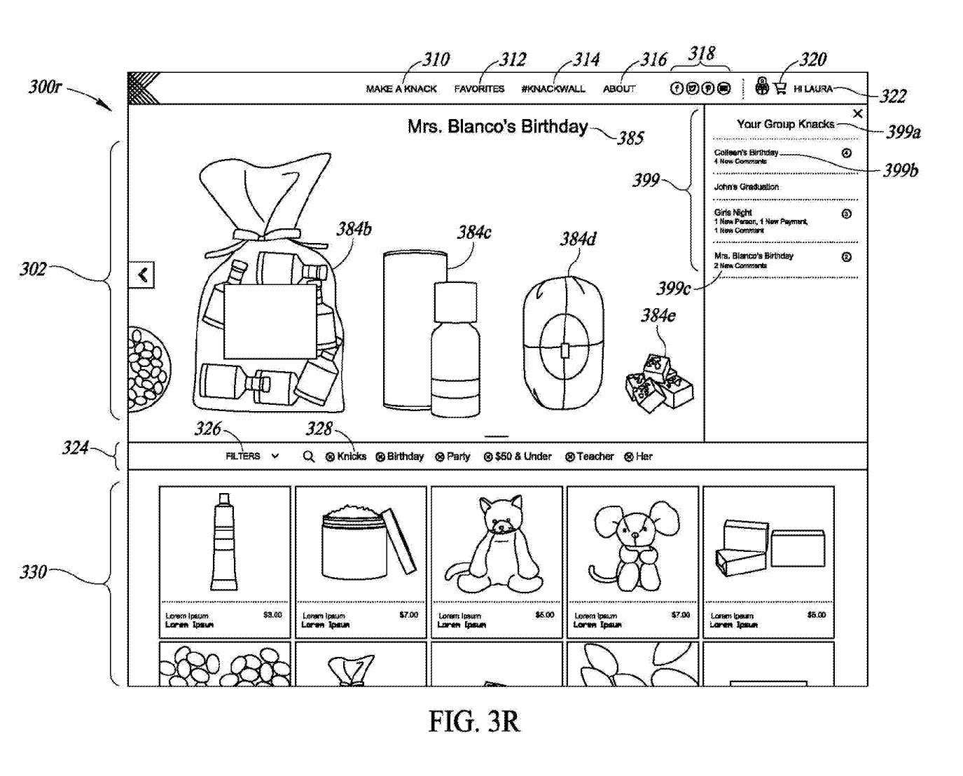

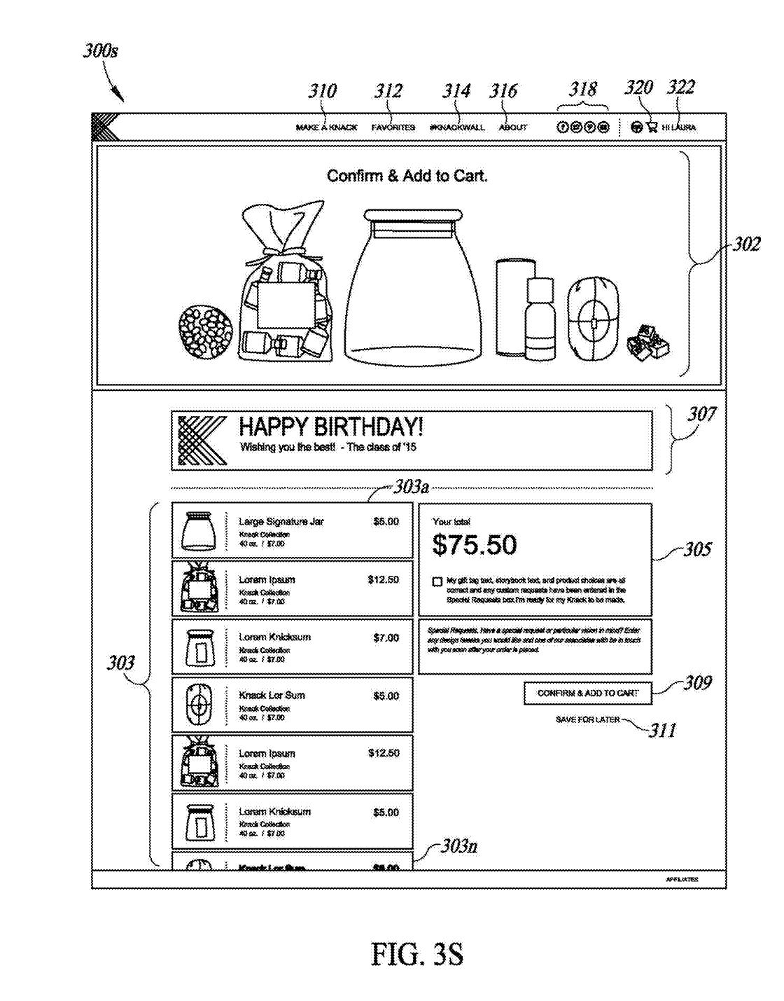

The article customization server computing system(s) 102 executes instructions stored on computer-readable media 102b that cause the article customization server computing system(s) 102 to provide a “maker stage” and associated tools that allow users to create articles comprised of a decorative, reusable container, a customized set of items that fit in the decorative container, a customized tag, and a customized storybook, as described herein, for example, with reference to FIGS. 3A-3S, below.

The article customization server computing system(s) 102 can allow one or more users to custom create or assemble articles, for example, gifts that comprise a custom selected decorative gift container, custom selectable set or bouquet of gift items (e.g., candies, candles, foods, jewelry, novelties, pet supplies, spa & beauty supplies including lotions, soaps, bath salts), a custom gift tag or card or product label, and a custom storybook that provides a narrative regarding the creation process, the various custom selected items, and if a gift, the reason(s) for the gift.

The article customization server computing system(s) 102 can allow one or more users to custom create or assemble articles from scratch, or by modifying a previously created article. Such can advantageously allow a user to create a custom article, for example, a gift, with a starting “template” defined by another person or persons, for example, a person who is particularly skilled or recognized at design, decorating, gift giving, or the domestic arts. The person can, for example, be a celebrity or other individual recognized for having a particular talent (e.g., chef, “mixologist” or bartender, home decorator, television personality, stylist, do-it-yourself (DIY) spokesperson). The person can, for example, be a non-celebrity or “regular” user who when creating a custom article is inherently defining a template that can be used by others, allowing every user to rise to the level of a creative hero or leader for other users.

The article customization server computing system(s) 102 can implement collaboration across two or more users in creating custom articles, for example, gifts, and/or in sharing costs associated with such custom articles. The article customization server computing system(s) 102 can provide tools for sharing custom designs and/or for collaboration using various social media platforms. The article customization server computing system(s) 102 can provide tools that control various levels of access to other users in a collaboration project.

In operation, the article customization server computing system(s) 102 may identify a subject of a file, for example, a subject of an HTML source file, based on a number of criteria regarding a filter or search query. The instructions may cause the article customization server computing system(s) 102 to identify one or more files, for example, one or more Web page source files. The article customization server computing system(s) 102 may identify multiple instances of files where, while a single logical address points to the file, the content of the file is different based on some factor, for example, where the content of the file is modified based on characteristics of the client accessing the file or a time that the file is accessed. For instance, a Web page may have active content that is modified to reflect a characteristic of the user or user client device accessing the Web page, for instance a geographical location of the user or user client device, a purchasing or browsing history of the user which represent previous purchases or previous Web page requests by the user, and/or previous articles created or assembled by the user. Thus, the article customization server computing system(s) 102 may solve existing problems.

The instructions may also cause the article customization server computing system(s) 102 to provide information to a user client device 104 that requested the file (e.g., Web page). For example, instructions may cause the article customization server computing system(s) 102 to provide the identified file(s) to a user client device 104, for example, for presentation as one or more tiles, expanded tiles, pop-up user interface elements, etc. Also for example, instructions may also cause the article customization server computing system(s) 102 to provide a forum, chat or blog directed or otherwise related to the determined subject of the requested file to a user client device 104 that requested the file (e.g., Web page). The forum, chat or blog may allow the sharing of information between users, including comments, opinions, views and/or suggestions, fostering collaboration. The article customization server computing system(s) 102 may provide such in a form that causes the user client device 104 to display the forum, chat or blog.

Also for example, instructions may also cause the article customization server computing system(s) 102 to provide one or more messages directed or otherwise related to the determined subject of the requested file to a user client device 104 that requested the file (e.g., Web page). The article customization server computing system(s) 102 may provide such in a form that causes the user client device 104 to display the message(s). Such message(s) may take a variety of forms, which may include advertisements or advertising. Also for example, instructions may also cause the article customization server computing system(s) 102 to provide one or more messages that are based on previous requests by the user client device 104, for example, a browsing history associated with the user client device 104, or user of such. The article customization server computing system(s) 102 may provide the messages in a form that causes the user client device 104 to display the message(s). Such message(s) may take a variety of forms, which may include advertisements or advertising.

One or more nontransitory media 102b can store information used to identify the subject of files, for example, in one or more databases, data stores or other data structures. The nontransitory media 102b can store information used to logically associate the subject of files to one or more criteria specified via filters and/or search queries. The nontransitory media 102b can store information that specifies available components to create articles, for example, information that specifies a plurality of available decorative containers to select from, and a plurality of available items to select from in assembling the article. The nontransitory media 106b can store information that specifies previously created articles, allowing such to be ordered without modification, or to serve as a base or template for modification in creating a new article, which new article can be ordered. Information can specify a size or dimension or volume of a decorative container and/or items. Information can specify a size or dimension of an opening of a decorative container and/or a size or dimension of an opening through which a respective item will fit. Information can specify a color or other physical characteristic of a decorative container and/or items. Information can specify a price of a decorative container and/or items to be received in and held by the decorative container. The decorative containers can be transparent or at least translucent, advantageously allow the items therein to be visible through the container, even where the container is colored (e.g., blue tinted glass). Containers can alternatively take the form of premium boxes, premium gift bags, premium diaper bags, premium cosmetic bags or cases, premium backpacks, premium handbags, etc. Such may or may not be decorative.

The nontransitory media 102b can store messages and information used to logically associate messages to a subject, for example, to a project to create an article or to the article itself. The nontransitory media 102b can store information used to logically associate messages with previous requests, for example, a browsing history of the requester. The nontransitory media 102b can store information used to logically associate two or more users collaborating on creation of a given article. Such can include identifying information that identifies the users, information that specifies a level of permission or authority that the given user has in viewing, contributing, modifying, adding and/or deleting with respect to the project.

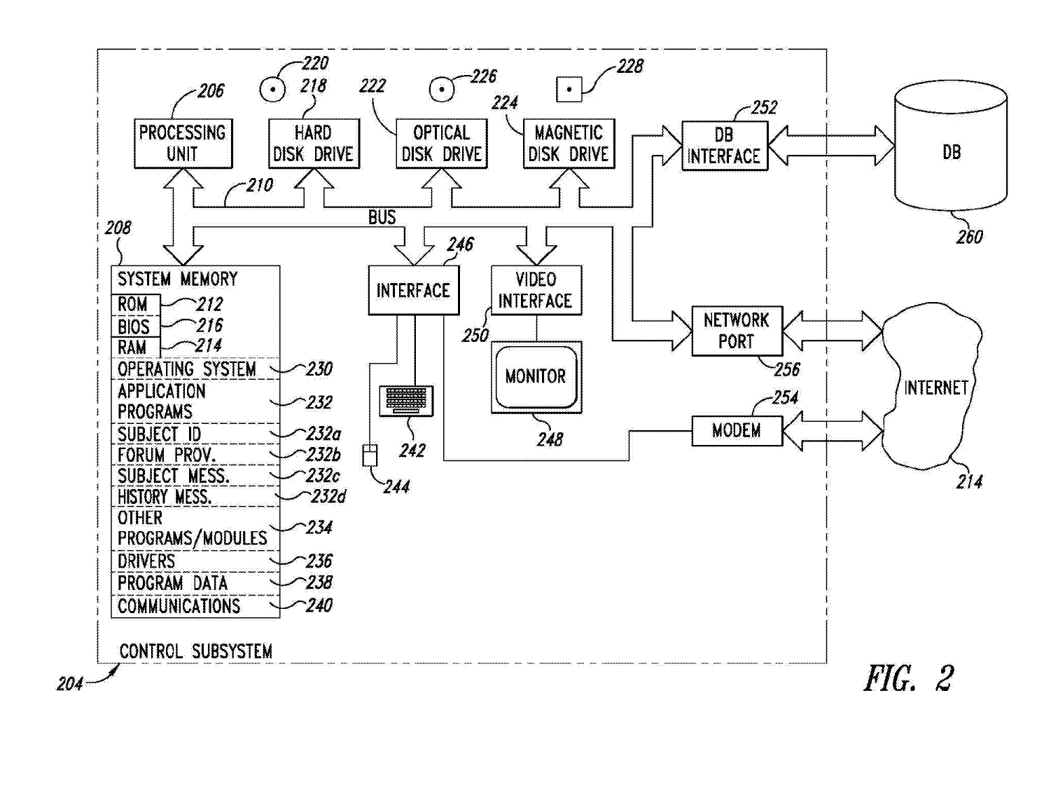

FIG. 2 and the following discussion provide a brief, general description of a suitable article customization server computing system(s) 204 in which the various illustrated embodiments can be implemented. The article customization server computing system(s) 204 may, for example, implement the various functions and operations discussed immediately above in reference to the article customization server computing system(s) 102 of FIG. 1.

Although not required, some portion of the embodiments will be described in the general context of computer-executable instructions or logic, such as program application modules, objects, or macros being executed by a computer. Those skilled in the relevant art will appreciate that the illustrated embodiments as well as other embodiments can be practiced with other computer system configurations, including handheld devices for instance Web enabled cellular phones or PDAs, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The article customization server computing system 204 may take the form of a conventional PC or hardware server executing instructions. The article customization server computing system 204 includes a processing unit 206, a system memory 208 and a system bus 210 that couples various system components including the system memory 208 to the processing unit 206. The article customization server computing system 204 will at times be referred to in the singular herein, but this is not intended to limit the embodiments to a single system, since in certain embodiments, there will be more than one system or other networked computing device involved. Non-limiting examples of commercially available systems include, but are not limited to, an 80x86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 206 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 2 are of conventional design. As a result, such blocks need not be described in further detail herein, as they will be understood by those skilled in the relevant art.

The system bus 210 can employ any known bus structures or architectures, including a memory bus with memory controller, a peripheral bus, and a local bus. The system memory 208 includes read-only memory (“ROM”) 212 and random access memory (“RAM”) 214. A basic input/output system (“BIOS”) 216, which can form part of the ROM 212, contains basic routines that help transfer information between elements within the control subsystem 304, such as during start-up. Some embodiments may employ separate buses for data, instructions and power.

The article customization server computing system 204 also includes a hard disk drive 218 for reading from and writing to a hard disk 220, and an optical disk drive 222 and a magnetic disk drive 224 for reading from and writing to removable optical disks 226 and magnetic disks 228, respectively. The optical disk 226 can be a CD or a DVD, while the magnetic disk 228 can be a magnetic floppy disk or diskette. The hard disk drive 218, optical disk drive 222 and magnetic disk drive 224 communicate with the processing unit 206 via the system bus 210. The hard disk drive 218, optical disk drive 222 and magnetic disk drive 224 may include interfaces or controllers (not shown) coupled between such drives and the system bus 210, as is known by those skilled in the relevant art. The drives 218, 222, 224, and their associated computer-readable media 220, 226, 228, provide nonvolatile storage of computer-readable instructions, data structures, program modules and other data for the article customization server computing system 204. Although the depicted article customization server computing system 204 employs hard disk 220, optical disk 226 and magnetic disk 228, those skilled in the relevant art will appreciate that other types of computer-readable media that can store data accessible by a computer may be employed, such as magnetic cassettes, flash memory cards, Bernoulli cartridges, RAMs, ROMs, smart cards, etc.

Program modules can be stored in the system memory 208, such as an operating system 230, one or more application programs 232, other programs or modules 234, drivers 236 and program data 238.

The application programs 232 may, for example, include search logic 232a, article creation or maker stage logic 232b, collaboration logic 232c, and reward logic 232d. The logic 232a-232d may, for example, be stored as one or more executable instructions.

As discussed in more detail below, the search logic 232a may include logic or instructions to search an inventory of previously created articles, available decorative containers, and available items to be received in the decorative containers based on one or more user specified criteria. Criteria can include a name of an article, name of a container, name of an item, name of a collection of articles, collection of containers or collection of items. Criteria can additionally or alternatively include a name of a creator of an article or name of manufacturer or distributor of a decorative container and/or item. Criteria can additionally or alternatively include a name of an intended recipient of the article that is being created. Criteria can additionally or alternatively include a category, occasion, type of event, type of holiday. Criteria can additionally or alternatively include a type of relationship to an intended recipient (e.g., family relationships such as father, mother, sister, brother, grandparent), or tile or position of the intended recipient (e.g., teacher, boss, mentor, friend). Again, the search logic 232a can implement searches based on filters (i.e., positive filter, negative filter) and or specific search criteria, for example, keyword searching.

As discussed in more detail below, the article creation or maker stage logic 232b may include logic or instructions to allow a user or users to create or customize an article. The article creation or maker stage logic 232b can allow the user or user to select a decorative container, including selecting various physical aspects of the decorative container, for instance size and/or color. The article creation or maker stage logic 232b can allow the user or user to select a set of items for inclusion in the decorative container, including selecting a quantity of the particular item as well as various physical aspects of the items, for instance color, size, etc. The article creation or maker stage logic 232b can advantageously verify that selected items will: i) fit through an opening in a selected decorative container, and ii) that a selected item will fit in a volume of the decorative container taking into account any other selected items to be received in the decorative container. Thus, the article creation or maker stage logic 232b can compare a size or dimensions of a selected article to a size or dimensions of an opening of a selected decorative container, providing an appropriate notification to the user (e.g., selected item too large). The article creation or maker stage logic 232b can also compare a cumulative volume of the selected items to a volume that the decorative container has been identified as capable of holding, and providing an appropriate notification to the user (e.g., too full to add the selected item). The article creation or maker stage logic 232b can also compare a total number of selected items to a total number of items that the container has been identified as capable of holding, and providing an appropriate notification to the user (e.g., too full to add selected item).

As discussed in more detail below, the collaboration logic 232c can implement collaboration between two or more users in creating an article. The collaboration logic 232c can allow a user to invite other users to collaborate on a project or article creation. The collaboration logic 232c can, for example, interface with one or more social networking platforms or electronic mail (email) messages. The collaboration logic 232c can allow a user to assign roles to themselves and to other users, for example, with an assigned or granted level of access, permission, authority or rights. For instance, the collaboration logic 232c can limit some users to viewing and/or financially contributing to creation or ordering of a particular project or custom article. Also for instance, the collaboration logic 232c can allow some users to add items to the article, while not allowing the user to remove or modify previously selected items. Also for instance, the collaboration logic 232c can allow some users to modify items, while not allowing the user to remove previously selected items. Also for instance, the collaboration logic 232c can allow some users to add, remove and modify items. Also for instance, the collaboration logic 232c can allow some users to modify or remove only items that the respective user added, while not allowing that user to modify or remove items added by other users. Also for instance, the collaboration logic 232c can allow some users to create, modify and/or delete a custom gift tag or portions thereof. Also for instance, the collaboration logic 232c can allow some users to create, modify and/or delete a custom storybook or portions thereof. Any combination of permissions can be granted.

As discussed in more detail below, the reward logic 232d can implement a rewards program for users or other contributors (e.g., celebrities). For example, the reward logic 232d can provide or assign a reward (e.g., points, credits, money, merchandise) to a user each time that an article created by the user is ordered, for example, ordered by another user. Additionally or alternatively, the reward logic 232d can provide or assign a reward to a user each time that an article created by the user is selected as a basis or template to create a new or modified article, for example, ordered by another user. Additionally or alternatively, the reward logic 232d can provide or assign a reward to a user each time that an article created based on an article created by the user is ordered. Thus, rewards can be implemented even though the user who originated the article is once removed from the article that is ordered. Thus, a user is motivated to create an article that is a popular template to create other, similar articles. Rewards may advantageously be implemented as donations to a charity or nonprofit organization, for example, a charity or nonprofit organization selected by the user who is being rewarded.

The system memory 208 may also include communications programs 240, for example, a server program and/or a Web client or browser program that permit the article customization server computing system 204 to access and exchange data with other systems or components, such as user client devices 104 (FIG. 1), intermediary ecommerce server computing systems 106 (FIG. 1), vendor computing systems 108 (FIG. 1), Web sites on the Internet, corporate intranets, or other networks as described below. The communications programs 240 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California, Microsoft of Washington, Apple Computer of California.

While shown in FIG. 2 as being stored in the system memory 208, the operating system 230, application programs 232, other programs/modules 234, drivers 236, program data 238 and server and/or browser 240 can be stored on the hard disk 220 of the hard disk drive 218, the optical disk 226 of the optical disk drive 222 and/or the magnetic disk 228 of the magnetic disk drive 224. A user can enter commands and information into the subject based communication facilitation server computing system 204 through input devices such as a touch screen or keyboard 242 and/or a pointing device such as a mouse 244. Other input devices can include a microphone, joystick, game pad, tablet, scanner, biometric scanning device, etc. These and other input devices are connected to the processing unit 206 through an interface 246 such as a universal serial bus (“USB”) interface that couples to the system bus 210, although other interfaces such as a parallel port, a game port or a wireless interface or a serial port may be used. A monitor 248 or other display device is coupled to the system bus 310 via a video interface 250, such as a video adapter. Although not shown, the control subsystem 304 can include other output devices, such as speakers, printers, etc.

The article customization server computing system 204 operates in a networked environment 100 (FIG. 1) using one or more of the logical connections to communicate with one or more remote computers, servers and/or devices via one or more communications channels, for example, one or more networks, for example, the Internet and/or Web 214. These logical connections may facilitate any known method of permitting computers to communicate, such as through one or more LANs and/or WANs, such as the Internet. Such networking environments are well known in wired and wireless enterprise-wide computer networks, intranets, extranets, and the Internet. Other embodiments include other types of communication networks including telecommunications networks, cellular networks, paging networks, and other mobile networks.

When used in a WAN networking environment, the article customization server computing system 204 may include a modem 254 for establishing communications over the WAN, for instance the Internet or Web 214. The modem 254 is shown in FIG. 2 as communicatively linked between the interface 246 and the Internet or Web 214. Additionally or alternatively, another device, such as a network port 256, that is communicatively linked to the system bus 210, may be used for establishing communications over the Internet or Web 214. Further, one or more network interfaces 252, communicatively linked to the system bus 210, can be used for establishing communications over a LAN. In particular, a database interface 252 may provide communications with one or more databases stored on one or more computer-readable media 260.

In a networked environment 100 (FIG. 1), program modules, application programs, or data, or portions thereof, can be stored in a server computing system (not shown). Those skilled in the relevant art will recognize that the network connections shown in FIG. 2 are only some examples of ways of establishing communications between computers, and other connections may be used, including wirelessly. In some embodiments, program modules, application programs, or data, or portions thereof, can even be stored in one of the user client devices 104 (FIG. 1), for example, as a “cookie” stored on a computer-readable storage medium of the client computing system or device.

For convenience, the processing unit 206, system memory 208, network port 256 and interfaces 246, 252 are illustrated as communicatively coupled to each other via the system bus 210, thereby providing connectivity between the above-described components. In alternative embodiments of the article customization server computing system 204, the above-described components may be communicatively coupled in a different manner than illustrated in FIG. 2. For example, one or more of the above-described components may be directly coupled to other components, or may be coupled to each other, via intermediary components (not shown). In some embodiments, system bus 210 is omitted and the components are coupled directly to each other using suitable connections.

FIGS. 3A-3S are screen prints of a user interface according to one illustrated embodiment, in the form of a collection of browser screens 300a-300s, respectively, as displayed on a display of a user client device 104 (FIG. 1).

The browser screens 300a-300r are similar in many respects, and similar or identical structures or elements are identified using the same reference numbers throughout FIGS. 3A-3S. In the interest of conciseness, only significant differences between the various Web browser screens 300a-300s are discussed below.

The user interface employs a variety of user selectable icons and/or other user selectable user interface elements, for instance pulldown menus, tiles, pop-up windows or panels, radio buttons, dialog boxes, etc. A user can select various user selectable icons and other user interface elements via any of a variety of manners, for example, with a cursor control device (e.g., mouse, trackball, trackpad, joystick, thumbstick) or, for example, with touch input via a touch screen interface or similar devices.

With reference to FIG. 3A, the browser screen 300a includes a “display” field (i.e., stage) 302a which displays information, for example in a slide show format. The display field 302a can be used to promote themes, functions and/or merchandise. As illustrated, the display field 302a shows example articles 304 (only one called out in FIG. 3A, i.e., denominated as KNACKS™ in the illustrations) that comprise containers 306 and sets or bouquets of a variety of items 308a, 308b, 308c (only three called out in FIG. 3A, collectively 308, i.e., denominated as KNICKS™ in the illustrations) that are held by the selected container 306. As illustrated, the containers 306 can be decorative containers that are re-useable, for instance glass jars with screw on lids, interference fit lids or hinged lids. Alternatively, some containers can take the form of premium boxes, premium gift bags, premium diaper bags, premium cosmetic bags or cases, premium backpacks, premium handbags, etc. Such alternative containers may or may not be decorative. The items 308 are typically selected from one or more curated sets of retail items, which may or may not include their own packaging.

The browser screen 300a includes a header bar 310 that has a number of user selectable icons (e.g., pull-down menus). The header bar 310 can, for example, include a “make a knack icon” user selectable icon 312, selection of which retrieves a Webpage (e.g., “make it” browser screen 300e, FIG. 3E) that allows a user to create an article or KNACK™ 304 comprised of a selected container 306 and a set of selected items or KNICKS™ 308. The header bar 310 can, for example, include a “favorites” user selectable icon 314, selection of which retrieves a favorites Webpage populated with articles or KNACKS™ 304, decorative containers 306 and/or items or KNICKS™ 308 which the respective user has previously identified as being favorites. The favorites Webpage populated with can also be populated with: i) KNACKS™ the user has already created and/or purchased; ii) KNACKS™ the user has saved; and/or iii) KNACKS™ that the user in the process or creating.

The header bar 310 can, for example, include a “#knackwall” user selectable icon, selection of which retrieves social posts with specific hashtags, for example, hashtags associated with the Website. The header bar 310 can, for example, include a “about” user selectable icon 316, selection of which retrieves and presents information about the entity that operates the Website. The header bar 310 can, for example, include a plurality of user selectable social media icons (collectively 318), selection of which allows the user to share articles or KNACKS™ 304, containers and/or items or KNICKS™ 308 with others via various social media platforms (e.g., FACEBOOK®, TWITTER®, PINTEREST®) or via electronic mail (i.e., email).

The header bar 310 can, for example, include a “shopping cart” field 319 via which the user receives notifications about collaborative projects with other users. The notifications can indicate whether the respective user has received an invitation from another user to collaborate on creating an article or KNACK™, or notification that another user has added a comment, or changed a KNACK™. The notifications are presented in abbreviated form in the header bar 310, and can be user selectable to take the user to a forum, chat or blog panel (e.g., forum, chat or blog window or panel 398 of FIG. 3O).

The header bar 310 can, for example, include a “shopping cart” user selectable icon 320, selection of which causes presentation of a checkout or order Webpage. The header bar 310 can, for example, include a “sign in” user selectable icon 322, selection of which causes presentation of a log in Webpage that allows the user to sign in or log in by supplying a user name and password.

The browser screen 300a includes a search bar 324, which includes a pull-down list of user selectable filters 326, and a user populatable search field 328. The filters and/or search field 326, 328 allow a user to filter or search for articles created by the user or by other users. The filters and/or search field 326, 328 allow a user to filter or search for containers, or for items or articles, or even for other content on the Website, for instance searching by merchant. The filters and/or search field 326, 328 allows a user to filter or search for items, for example, from a curated collection of items or KNICKS™. The filters and/or search field 326, 328 allows filtering or searching by a large variety of different filter or search criteria.

The browser screen 300a includes a results field 330 in which results of a user invoked searches are displayed. The results field 330 is separated from the display field 302a or “maker stage” field 302b (FIG. 3E) by the search bar 324. The system can display the results in the form of tiles, which populate the results field 330. For example, results of a search for articles 304 (i.e., KNACKS™) can be presented as a set of article tiles 332a, 332b (only two called out in FIG. 3A, collectively 332), as illustrated in FIG. 3A. Results of a search for a container 306 can be presented as a set of container tiles 334a, 334b (only two called out in FIG. 3F, collectively 334) as illustrated in FIG. 3F. Results of a search for an item 308 (i.e., KNICKS™) can be presented as a set of item tiles 336a, 336b (only two called out in FIG. 3I, collectively 336), as illustrated in FIG. 3I.

The results field 330 can optionally include results from system invoked searches. For example, the results field 330 may present tiles 332, 334, 336 for articles, containers or items that are selected based on previous selections or purchases by a user, current previous selections or purchases by a user, previous selections or purchases by an intended recipient, current previous selections or purchases by an intended recipient, and/or based on selections or purchases by other users who have made identical or similar selections to the user or the intended recipient.

The titles 332, 334, 336 may each include a corresponding image (e.g., photograph, picture) of the article 304, decorative container 306 or item 308. For example, each article tile 332 includes an image (e.g., photograph, picture) 340a of the corresponding article 304 (i.e., Knack) as illustrated in FIG. 3A. For instance, an image or photograph of an article can be captured just prior to shipping, and made available via the system. Also for example, each container tile 334 includes an image (e.g., picture) 340b of the corresponding container 306, as illustrated in FIG. 3F. Also for example, each item tile 336 includes an image (e.g., picture) 340c of the corresponding item 308 (i.e., Knick), as illustrated in FIG. 3I.

Where the result identifies an instance of an article 304, as illustrated in FIG. 3A, the article tile 332 can also include an indication 342a of a person or entity that created the corresponding article 304, for instance a name or nickname. In some instances, the person may be a celebrity or have a following, and can be the subject of a search query. The article tile can also include an image 344 of the person or entity that created the article 304, for instance a picture or photograph. The article tile 332 can also include an indication of an article name assigned to the article 304, for instance in an article name field 346a. The individual or entity that created or otherwise provided the article can assign or pick the article name. The article tile 332 can also include an indication of a time when the article was created or posted, for instance in a time field 348. The article tile 332 can further include an indication of a price associated with the article 304, for example, in a price field 350a. It is noted that an editor that works for Website or Web portal will also be able to name, describe and publish any article, container or item information and graphics to a homepage of the Website or Web portal. The maker can opt-out so that their article, container or item is not published online by the Website or Web portal editor—but this is a publishing function that the Website or Web portal owner can control.

Where the result identifies an instance of a container 306, as illustrated in FIG. 3F, the container tile 334 can include an indication of a container name assigned to the container 306, for instance in a container name field 346b. The entity that manufacturers, distributes or otherwise provided the container 306 can assign or pick the container name. The container tile 334 can also include an indication of a collection to which the corresponding container 306 belongs, for instance in a collection field 352a. The collection can be assigned and/or named by the manufacturer or distributor, or can be specific to the Website. The container tile 334 can further include an indication of a price associated with the article 304, for example, in a price field 350b.

Where the result identifies an instance of an item 308, as illustrated in FIG. 3I, the item tile 336 can include an indication of an item name assigned to the item 308, for instance in an item name field 346c. The entity that manufacturers, distributes or otherwise provided the item 308 can assign or pick the item name. The item tile 336 can also include an indication of a collection to which the corresponding item 308 belongs, for instance in a collection field 352b. The collection can be assigned and/or named by the manufacturer or distributor, or can be specific to the Website. The item tile 336 can further include an indication of a price associated with the item 304, for example, in a price field 350c.

Selection of a tile 332, 334, 336, for instance one of the article tiles 332 results in presentation of a corresponding expanded article tile 332c, as visible in browser screen 300b of FIG. 3B, expanded container tile 334c, as visible in browser screen 300g of FIG. 3G, and expanded item tile 336c, as visible in browser screen 300j of FIG. 3J, respectively.

With reference to the Web browser screen 300b of FIG. 3B, in addition to those elements (i.e., article name field 346a, creator name field 342a, creator image or picture 344, price field 350a) provided by the corresponding (i.e., unexpanded) article tile 332a, the expanded article tile 332c includes a synopsis of the corresponding article in a synopsis field 356. The synopsis can be generated by the individual or other entity that created the article 304 to which the article tile 332c corresponds, or alternatively, the synopsis the operator of the Website supply the synopsis.

The expanded article tile 332c may include a number of user selectable icons. For instance, the expanded article tile 332c may include a user selectable “favorites” icon (identified with an image of a heart) 358a, selection of which sets a flag or stores information indicating that the user considers the article 304 a favorite, to allow easy navigation back to the article. Also for instance, a “sharing” user selectable icon 360a allows a user to share the article, container or item with others, for example, via one or more social media platforms or email. For example, selection of a “sharing” user selectable icon changes the expanded article tile 332c to present a number of user selectable icons corresponding to, for example, FACEBOOK, TWITTER, PINTEREST, as well as electronic mail.

The expanded article tile 332c can include a “see what's inside” user selectable icon 362a that allows a user to select the article 304 to either order or to modify or to order or modify components of the article 304. Selection of the “see what's inside” user selectable icon 362a can cause presentation of a “what's inside” pop-up user interface element 364a, for example, as illustrated in Web browser screen 300d of FIG. 3D, discussed below.

The expanded article tile 332c can include a “start here” user selectable icon 363a that allows a user to select the article 304 to serve as a base or template to modify, or alternatively to order without modifications. In response to selection of the “start here” user selectable icon 363a the system populates a data structure for the article 304 being created with the specifics of the decorative container 306 and various items 308 of the corresponding article 304 of the article tile 332. In response to selection of the “start here” user selectable icon 363a the system may optionally updates the “display” field 302a with images of the decorative container 306 and various items 308 of the corresponding article 304 of the article tile 332, for example, as illustrated in Web browser screen 300l of FIG. 3L, or in Web browser screen 300m of FIG. 3M, discussed below. Such can serve as a base or template that the user can modify to customize the article 304, for example, by changing the container 306, adding, deleting or modifying (e.g., quantity, color) the items 308.

With reference to the Web browser screen 300g of FIG. 3G, in addition to those elements (i.e., image 340b, name field 346b, collection field 352a, price field 350b) provided by the corresponding (i.e., unexpanded) container tile 334a, the expanded container tile 334c includes a number of user selectable icons.

For instance, the expanded container tile 334c may include a user selectable “favorites” icon (identified with an image of a heart) 358b, selection of which sets a flag or stores information indicating that the user considers the container 306 a favorite, to allow easy navigation back to the container 306. Also for instance, a “sharing” user selectable icon 360b allows a user to share the container 306 with others, for example, via one or more social media platforms or email. For example, selection of a “sharing” user selectable icon 360b changes the expanded container tile 334c to present a number of user selectable icons corresponding to, for example, FACEBOOK, TWITTER, PINTEREST, as well as electronic mail.

The expanded container tile 334c can include a “more” user selectable icon 362b. Selection of the “more” user selectable icon 362b can cause presentation of a “container detailed” pop-up user interface element 364b, for example, as illustrated in Web browser screen 300d of FIG. 3D, discussed below.

The expanded container tile 334c can include a “size” user selectable list or pull-down menu 366a that allows a user to select from a number of sizes (e.g., 20 oz, 40 oz, small, medium, large) of the corresponding type of container 306 to add to an article 304 being created.

The expanded container tile 334c can include a “color” user selectable list or pull-down menu 368a that allows a user to select from a number of colors (e.g., clear, red, green, mixed, striped) of the corresponding type of container 306 to add to an article 304 being created.

The expanded container tile 334c can include a “use container” user selectable icon 363b that allows a user to select the corresponding container 304 to add to an article 304 or to order directly. In response to selection, the information that identifies the corresponding container, including selected size and color, is added to an article definition data structure and an image of the container is added to the “display” field 302a, for example, as illustrated in the Web browser screen 300h of FIG. 3H and Web browser screen 300i of FIG. 3I.

With reference to the Web browser screen 300j of FIG. 3J, in addition to those elements (i.e., image 340c, name field 346c, collection field 352b, price field 350c) provided by the corresponding (i.e., unexpanded) item tile 336a, the expanded article tile 336c includes a number of user selectable icons.

For instance, the expanded item tile 336c may include a user selectable “favorites” icon (identified with an image of a heart) 358c, selection of which sets a flag or stores information indicating that the user considers the item 308 a favorite, to allow easy navigation back to the item 308. Also for instance, a “sharing” user selectable icon 360b allows a user to share the item 308 with others, for example, via one or more social media platforms or email. For example, selection of a “sharing” user selectable icon 360b changes the expanded item tile 336c to present a number of user selectable icons 359a, 359b (only two called out) corresponding to, for example, FACEBOOK, TWITTER, PINTEREST, as well as electronic mail.

The expanded item tile 336c can include a “more” user selectable icon 362c. Selection of the “more” user selectable icon 362b can cause presentation of a “item detailed” pop-up user interface element 364c, for example, as illustrated in Web browser screen 300k of FIG. 3K, discussed below.

The expanded item tile 336c can include a “quantity” user selectable list or pull-down menu 366b that allows a user to select from a number of instances (e.g., 1, 2, 3, 5, 12) of the corresponding type of item 308 to add to an article 304 being created.

The expanded container tile 334c can include a “color” user selectable list or pull-down menu 368b that allows a user to select from a number of colors (e.g., clear, red, green, mixed, striped) of the corresponding type of item 308 to add to an article 304 being created.

The expanded item tile 334c can include an “add item” (i.e., ADD KNICK) user selectable icon 363c that allows a user to select the corresponding item 308 to add to an article 304 being created or to order directly. In response to selection, the information that identifies the corresponding item 308 is added to an article definition data structure and an image 384b of the item 308 is optionally added to the “display” field maker stage 302a, for example, as illustrated in the Web browser screen 300l of FIG. 3L and Web browser screen 300m of FIG. 3M.

As previously explained, selection of the “see what's inside” user selectable icon 362a (FIG. 3B) can cause presentation of a “what's inside” pop-up user interface element 364a. With reference to the Web browser screen 300d of FIG. 3D, in addition to those elements (i.e., article name field 346a, price field 350a) provided by the corresponding unexpanded article tile 332a and expanded article tile 332c, the “what's inside” pop-up user interface element 364a includes a an expanded synopsis of the article 304 in an expanded synopsis field 370a. The “what's inside” pop-up user interface element 364a can also include a list of the components that comprise the article, including container and items, in a components list field 372a. Each component (e.g., decorative container 306, item 308) is identified in a respective line by an image 373, a name or title 374, and a cost or amount 375 (only one of each called out in FIG. 3D) of the respective component. The “what's inside” pop-up user interface element 364a can include a scroll bar 376, selection and manipulation of which allows the user to scroll up or down through the list, particularly where the list exceeds a dimension of a list field or window 372a.

The “what's inside” pop-up user interface element 364a can optionally include left and right scroll or index icons 377a, allowing a user to quickly scroll or index between other images of the corresponding article or KNACK™ 304. The “what's inside” pop-up user interface element 364a can also include a position indicator 378a, which represents a current position in a set of images or pictures of the article 304 relative to other ones of pictures of the article in the set of images or pictures, and is updated in response to scrolling or indexing left or right.

The “what's inside” pop-up user interface element 364a can include a “close” user selectable icon 379a. Selection of the close user selectable icon 379a causes the “what's inside” pop-up user interface element 364a to disappear.

The “what's inside” pop-up user interface element 364a can include a “make it” user selectable icon 380, selection of which allows a user to modify a selected starting article 304, for example, changing a container 306 or one or more items 308.

In response to selection of the “make it” user selectable icon 380, the system causes a presentation of a “make it” browser screen 300e, illustrated in FIG. 3E.

With reference to FIG. 3E, the browser screen 300e includes a “maker stage” field (i.e., stage) 302b in which articles 304 (only one called out in FIG. 3A, i.e., denominated as KNACKS™ in the illustrations) such as sets or bouquets of are created from containers 306 and a variety of items 308a, 308b, 308c (only three called out in FIG. 3A, collectively 308, i.e., denominated as KNICKS™ in the illustrations) that are held by the selected container 306.

The “make it” browser screen 300e populates a “maker stage” field 302b with a “container selection” user selectable icon 381 for selecting a container 306, one or more “item selection” user selectable icons 382a, 382b, 382c (three shown, collectively 382) for selecting items 308, and a “customize supporting content” user selectable icon 383 for selecting and/or customizing a custom storybook, custom label and/or custom tag, which can be part of the article 304. Notably, the make it” browser screen 300e, illustrated in FIG. 3E can also or alternatively be presented when the user selects to create an article or KNACK™ 304 from scratch, instead of using another article or KNACK™ 304 as a base or template.

As illustrated in the Web browser screen 300f of FIG. 3F, selection of the “container selection” user selectable icon 381 causes presentation of a number of available containers in the results field 330, for example containers from a collection of containers. The results can be represented as a number of “container” tiles 334, one “container” tile for each container 306. As previously described, the “container” tiles 334 can include an image 340b of the corresponding container 306, name or title for the corresponding container in a name or title field 346b, name of a collection in a collection field 352 to which the corresponding container belongs, and a price of the corresponding container in a price field 350b.

Selection of “item selection” user selectable icons 382 causes presentation of a number of available items or KNICKS™ in the results field 330, for example items from a collection of items.

The “maker stage” field 302b can includes one or more rulers 331 (only one shown) that extends along a respective axis of the “maker stage” field 302b. The ruler 331 sized to be the dimension of a size of a largest component, typically the container 306. As components (e.g., items 308) are selected or added, corresponding images are adjusted in size so that selected components (i.e., container 306, items 308) are advantageously all displayed proportionately with respect to one another. This unique feature allows easy visual comparison by the user.

The images (e.g., photographs) added to the “maker stage” field 302b can be tagged with information or metadata. Thus, when a component (e.g., container 306 or item 308) is represented by more than one image, the correct image is presented to the user via the “maker stage” field 302b.

A final packaged size of each component (e.g., container 306 or item 308) is captured using metafields, for example as height, length, and depth metafield data. The information stored in the metafields is used to display the corresponding images correctly, in proportion to other components on the “maker stage” field 302b.

As illustrated in FIG. 3G, the user can select any of the “container” tiles 334b to cause presentation of an expanded “container” tile 334c. The expanded “container” tile 334c includes all of the information as the corresponding unexpanded container tile 334b, and adds additional user selectable icons or other user selectable structures to obtain additional information about the corresponding container, discussed above.

On selection of the “use container” user selectable icon 363b, the “maker stage” field 302b is updated to present an image 384a of the selected container 304, as illustrated in Web browser screen 300h of FIG. 3H. The “maker stage” field 302b can include a user selectable or fillable “article naming” icon or field (i.e., Name your Knack) 385, which allows the user to assign a name of for the article 304 being created by the user. The assigned name can later be used for searching or sharing with others.

The “maker stage” field 302b can include a user selectable “add” icon 386, selection of which causes presentation of a Web browser screen similar to Web browser screen 300e of FIG. 3E. The “maker stage” field 302b can include a user selectable “invite” icon 387 that allows the user to invite others to help generate or assemble the article. The “maker stage” field 302b can provide an indication of an amount of progress, for example, a “percentage full” indication or field 388. The percentage of completion can be calculated as the actual or an estimate of an amount of volume of the container, and a cumulative volume of selected items for the particular article that is being created. The “maker stage” field 302b can include an indication of total cost or total cost field 389.

The “maker stage” field 302b can include a “save it” user selectable icon 390, selection of which causes the system to save the article 304 including the current specifications for the selected container 306 and any selected articles 308, for later retrieval. Such can allow the user to take a break from creating a given article 304, or allow another user to work on the article 304.

As illustrated in FIG. 3I, the user can use filters 326 or the search field 328 to automatically identify suitable items 308 to choose from in creating the article 304. In particular, FIG. 3I shows search criteria as KNICKS™ (i.e., items to include in the container), birthday and party. The results field 330 is populated with results, for example, in the form of tiles 336a, 336b, that correspond to items 308 that meet the user specified criteria.

As illustrated in the Web browser screen 300j of FIG. 3J, the user can select on one of the item tiles 336a in the results field 330, which causes presentation of an expanded “item” tile 336c, as previously described. As also previously described, the user can select on the “more” user selectable icon 362c, which causes presentation of the “item detailed” pop-up user interface element 364c, for example, as illustrated in Web browser screen 300k of FIG. 3K.

The “item detailed” pop-up user interface element 364c includes much of the same information as the expanded “item” tile 336c, for example, one or more images of the corresponding item 308, item name in an item name field 346c, cost in a cost field 350c, expanded synopsis in an expanded synopsis field 370b, user selectable quantity and color lists or pull-down menus 366b, 368b. The “item detailed” pop-up user interface element 364c can include a “close” user selectable interface element 379b. The “item detailed” pop-up user interface element 364c can optionally include left and right scroll or index icons 377b, allowing a user to quickly scroll or index between other images of the corresponding item or KNICK™ 308. The “item detailed” pop-up user interface element 364c can optionally include a position indicator 378, which represents a current position in a set of images or pictures of the item 308 relative to other ones of pictures of the item in the set of images or pictures, and is updated in response to scrolling or indexing left or right.

The “item detailed” pop-up user interface element 364c includes an “add item” (i.e., ADD TO KNACK) user selectable icon 392, selection of which causes the system to store the selected item, including selected quantity and/or color, for use in creation or modification of an article. In response to selection of the “ADD TO KNACK” user selectable icon 392, the system adds the corresponding item to a list or other data structure that specifies the components of the given article. In response to selection of the “ADD TO KNACK” user selectable icon 392, the system also updates the “maker stage” field 302b with an image of the selected item 308, for instance as illustrated in FIG. 3L. In response to selection of the “ADD TO KNACK” user selectable icon 392, the system updates the indication in the amount of progress or “percentage full” field 388, as well as updating the indication of total cost or total cost field 389, for instance as illustrated in the Web browser screen 3I of FIG. 3L.

The “item detailed” pop-up user interface element 364c includes an “add to cart” (i.e., ADD TO CART) user selectable icon 393, selection of which causes the system to store information about the selected item 308, including selected quantity and/or color, to a virtual shopping cart for purchase. Thus, a user can elect to purchase an item 308 separately from an article 304.

As illustrated in the Web browser screen 300l of FIG. 3L, the “maker stage” field 302b can include a “summary” pop-up user interface element 394. The “summary” pop-up user interface element 394 can be presented in response to a user selection of an image 384 of a container 306 or item 308 in the “maker stage” field 302b. The “summary” pop-up user interface element 394 can include summary information, for example, a name of the corresponding container 306 or item 308 in a name field 394a, size, quantity and/or color of the corresponding container 306 or item 308 in corresponding fields 394b, 394c. The “summary” pop-up user interface element 394 can include one or more user selectable icons. For example, the “summary” pop-up user interface element 394 can include a “remove” user selectable icon 394d, selection of which removes the corresponding container 306 or item 308 from the article 304 being created by the user(s). For example, the “summary” pop-up user interface element 394 can include an “edit” user selectable icon 394e, selection of which causes presentation of a user interface element that allows editing of the corresponding container 306 or item 308 from the article 304 being created by the user(s), for example, the “item detailed” pop-up user interface element 364c. The “summary” pop-up user interface element 394 can include a “close” user selectable icon 394f, selection of which closes the “summary” pop-up user interface element 394.

As illustrated in the Web browser screen 300m of FIG. 3M, the user can use the filters and/or search field to specify various filters or search criteria. The filters and/or search field allows a user to filter or search for articles created by the user or by other users, for containers, and/or for items, for example, from a curated collection of items.

In particular, the Web browser screen 300m of FIG. 3M shows a collection of user selectable filters or search criteria 395. The collection of user selectable filters and/or search 395 allows filtering or searching by a large variety of different filter or search criteria for instance, category (e.g., candy, candles, celebration, gift, food, jewelry, novelty, pet, spa & beauty), price (e.g., ranges of dollar values), color, recipient (e.g., gender, position, relationship), occasion (e.g., birthday, holiday, special event), and/or affiliate (e.g., manufacturer or distributor of a given container or item).

As illustrated in the Web browser screen 300n of FIG. 3N, the “maker stage” field 302b can be populated with images of a selected container 384 and images 384b-384e of a plurality of selected items 308 which the container 306 will hold as part of the article 304. The indication of an amount of progress or “percentage full” indication is provided in the progress field 388 is updated to reflect the current selection of container 306 and items 308, as is the indication of total cost or total cost field 389. The article may include a user assigned name, such as “Mrs. Blanco's Birthday” which is indicated in the article name field 385.

As illustrated in FIG. 3N, the user can select the “invite” user selectable icon 396 to invite others to join in creating the article. Such advantageously allows collaboration between two or more people in creating an article, for example, a gift. Selection of the “invite” user selectable icon 396 causes presentation of a user interface element that allows the user to invite others to join the group or collaboration, for example, via one or more social media platforms and/or email.

As illustrated in the Web browser screens 300o, 300p, 300q of FIGS. 3O-3Q, respectively, selection of an “invite” user selectable icon 396 can cause presentation of collaboration window or panel 397. The user can set a deadline via a “calendar” user selectable icon or tool 397a, which will display in a deadline in a deadline field 397b of the collaboration window or panel 397 of any users who are part of a group or collaboration.

The user can select ON or OFF toggle 397c to activate or deactivate a payment function, which allows members of the group or collaboration to pool money or payment. The collaboration window or panel 397 may include a contribution field 397d that shows a current level of contributions committed to the collaboration or group project.

The user can select a “people” user selectable icon 397e to cause a display of the members of the group or collaborators or invitees. Each of the members of the group or collaborators or invitees can be presented on a respective line.

One or more “permissions” user selectable icons 397f (only one called out in FIG. 3O) can be selected to set a level of permission, authority or right that is granted to the respective user with respect to a project or article 304. The user can control or grant respective levels of authority or permissions to different invitees to take certain actions. For example, the user can grant some invitees the authority, permission or right to only view the article being created, and to contribute financially to the collaboration. The user can grant others invitees the authority, permission or right to add items, but not to remove, change or modify any items. The user can grant still others invitees the authority, permission or right to add items, remove items, replace items, and/or change or modify items (e.g., change a color of an already selected item).

The user can select a “comments” user selectable icon 397g to display comments or not. The comments can be presented in a forum, chat or blog window or panel 398.

As illustrated in FIG. 3R, the can display a list 399 of all group collaborations that the user is involved with, allow the user to quickly switch between groups. The list 399 can include an indication of name of the article 399a, the individuals 399b in the respective group, as well as recent events (e.g., new comments, new people, new payments, new commitments) 399c occurring in the group.

As illustrated in FIG. 3S, a Web browser screen 300s can display a itemization 303 of the components for a given article. The itemization 303 can include line item 303a-303n (collectively 303) for a container 306 and each of item 308 of the respective article 304, with accompanying graphic or picture, name, collection identifier, size, color, price, etc. The Web browser screen 300s can include an indication of the total cost or price in a total field 305. The Web browser screen 300s can include a salutation field 307 that presents a salutation message that can be provided along with the article 304, for example, on a customized tag or customized storybook.

The Web browser screen 300s can include a “confirm & add to cart” user selectable icon 309, selection of which adds the article 304 to a virtual shopping cart in the form of one or more article components (i.e., container 306, items 308). The user can place an order for the article 304 via the virtual shopping cart, and have the order automatically fulfilled. Using this approach advantageously takes advantage of existing virtual shopping cart functionality, which may, for example, be provided by another entity or separate entity from the entity that provides or sells the articles. Such typically includes populating billing information, shipping information, and payment information, and can take advantageous of pre-populated billing, shipping and/or payment information.

The Web browser screen 300s can include a “save for later” user selectable icon 311, selection of which saves the article and components to a memory or storage media, so the user can quickly return to the article, for example, to add the article 304 to a virtual shopping cart or modify the article 304. Such may employ one or more cookies on a user processor-based device to allow retrieval of the stored information. Using this approach advantageously takes advantage of existing “save for later” functionality, which may, for example, be provided by another entity or separate entity from the entity that provides or sells the articles.

The Web browser screens 300 can display results of a request for a file. The results of the file request may, for example, take the form of a Webpage. The content of the Webpage may include text, character strings of alpha, numeric or other symbols, pictures, user selectable icons or menus, as well as various active content. For example, the content of the Webpage may include a one or more tiles for an article 304, a container 306 or items 308. The content of the Web browser screens 300 or Webpages can be active content. The content of the Web browser screens 300 or Webpages may also employ or encode a logical address of a file, for example, a uniform resource locator (URL) used to retrieve the file, including a domain portion of the URL. The content of the Web browser screens 300 or Webpages may include an image such as a photograph or picture of an article, container and/or item. The content of the Web browser screens 300 or Webpages may include a menu (e.g., pull-down menu) which may be selectable by a user. The content of the Web browser screens 300 or Webpages may include one or more user selectable icons for accessing content or selecting content. The content of the Web browser screens 300 or Webpages may include a retail price or normal price at which the product is offered. The content of the Web browser screens 300 or Webpages may include other descriptive information or use selectable icons to review articles, containers, items, for example, information about the articles, containers, items, creators of articles, collaboration information, shipping information, and/or any return policies.

The Web browser screens 300 or Webpages, or a window proximate the Web browser screens 300 or Webpages, may include a forum window that displays a forum, chat or blog panel that includes information about the subject of a project to create an article. The information may include comments, opinions, views, and/or suggestions between multiple participants of the forum. The content of the forum, chat or blog is preferably controlled by an entity that has no financial or other stake in sales of the product. Thus, the forum is preferably controlled by an entity that is not the manufacturer, distributor, retailer or wholesaler of the product or other subject of a Web page displayed in the browser window.

The information or content of Web browser screens 300 or Webpages may, for example, be stored as raw Web page content including images, formatting information (e.g., both HTML-based as well as Cascading Style Sheets or CSS information) and/or supplementary information (e.g., logical address such as a URL).

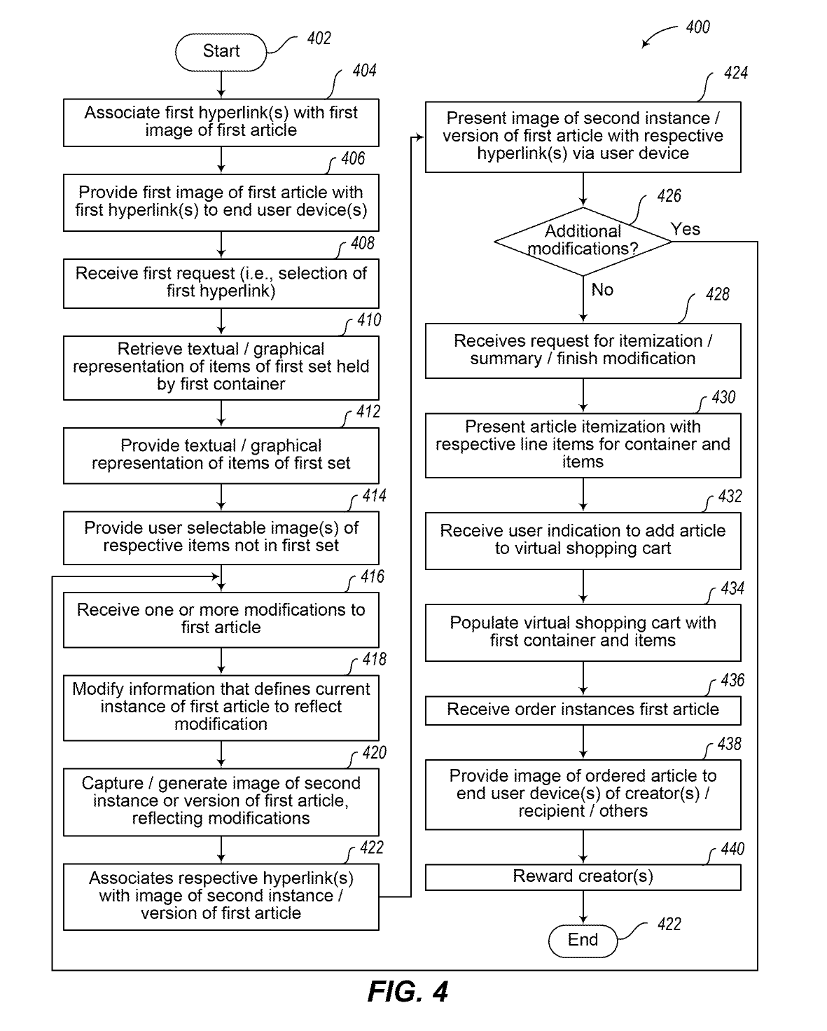

FIG. 4 shows a method 400 of operation in a system to generate customized orderable articles, accordingly to at least one illustrated implementation. The system can comprise at least one processor and at least one processor-readable medium communicatively coupled to the at least one processor, and at least one communications port that provides communications, for example, with one or more end user processor-based devices.

The method 400 can be implemented for each of a plurality of articles which are each created by one or more end users, in many instances using a first instance of a first article as a basis or template to create a customized article, for example, by changing a container or contents (i.e., items) held by the container, and/or customizing a tag and/or storybook that accompanies, and is considered part of, the article.

Images and hyperlinks described herein can, for example, be presented as tiles, expanded tiles, and/or pop-up user interface elements with images, text, user-selectable icons and other user interface elements.

The method 400 starts at 402, for example, in response to a power up of the system, receipt of a Webpage request, or invocation of a calling routine.

At 404, at least one processor associates at least a first hyperlink with a first image of a first article.

At 406, the at least one processor provides or causes to be provided a first image of a first article along with at least the first hyperlink to one or more end user devices. The hyperlink can be provide along with or embedded in the first image. Selection of the hyperlink can cause a presentation of the contents of the article, for example, container and items of a first set of items, allowing modification or customization of the article.

At 408, the at least one processor receives a first request indicative of a selection of the first hyperlink. In response to receipt of the first request, the at least one processor performs a series of acts (i.e., one or more of 406-422), discussed below.

At 410, the at least one processor retrieves a textual and/or graphical representation of each of two or more items of the first set of items held by the first container. At 412, the at least one processor provides or causes to be provided a textual and/or graphical representation of at least a subset of each of the two or more items of the first set of two or more items held by the container to the at least one end user device. Optionally, at 414 the at least one processor provides or causes to be provided a plurality of user selectable images of respective ones of a plurality of items that are not in the first set of two or more items held by the container to the at least one end user device. Such can be in response to a query, search or filtering performed by the at least one processor in response to one or more end user inputs. The images can include or be associated with one or more hyperlinks, selection of which allows an end user to add additional items to the set of items.

At 416, the at least one processor receives an indication of that identifies one or more modifications to the first article (e.g., modification to a first set of two or more items to create a second set of two or more items, and hence a second instance or version of the first article). Modifications can include any one or more of: changing a container or a physical aspect of a container, for instance a size or color of the container; removing an item from the set, adding an item to the set, replacing one item for another item in the set, adjusting a size of an item in the set, changing a color or other physical characteristic of an item in the set, or changing a quantity of an item in the set.

At 418, the at least one processor modifies a set of information that defines the current instance of the article to reflect the modification. At 420, the at least one processor can capture or generate an image of second instance or version of the first article, reflecting any modifications thereto. For example, the at least one processor can capture or generate an image of the second instance or version of the first article before to shipping the second instance or version of the first article to an intended recipient. At 422, the at least one processor can associate a respective hyperlink with the image of second instance or version of the first article. At 424, the at least one processor can present or cause to be presented the image of second instance or version of the first article along with the respective hyperlink to a user via the end user device. At 426, the at least one processor determines whether there are additional modifications. This portion (i.e., 410-422) of the method 400 can iterate over one or more cycles as one or more users modify the base or template article and/or subsequent instances or versions of such (e.g., first, second, third instances of the article based on first, second, or third set of items and/or different or modified containers to hold the items, and update hyperlinks), to refine or otherwise customize the article. Likewise, the method 400 can be repeated for numerous articles, some of which can be based on previous instance or versions of articles.

At 428, the at least one processor receives a request for an itemization, summary or to finish the modification process. At 430, the at least one processor presents or causes a presentation of an article itemization with respective line items for each of the first container and the items in the second set of two or more items, before receiving the order for the second instance of the first article that includes the second set of two or more items. At 432, the at least one processor receives a user indication to add the article (e.g., each of the first container and the items in the second set of two or more items) to a virtual shopping cart. At 434, in response to receipt of the user indication, the at least one processor populates the virtual shopping cart with the first container and each of the items in the second set of two or more items, before receiving the order for the second instance of the first article that includes the second set of two or more items.

At 436, the at least one processor receives an order for at least one of the first, the second or additional instances of the first article that includes the respective sets of two or more items and/or respective containers that corresponds to any modifications to the first set of two or more items. At 438, the at least one processor can provide or cause to be provided an image of the ordered article to a respective end user device associated with one or more creators of the respective article and/or recipient of the respective article. In particular, the at least one processor can provide or cause to be provided an image of the ordered article along with a hyperlink to access an article tile for the respective article or alternatively an itemization for the respective article. Access to the itemization for the respective article can be limited to the creator or to those who are not intended recipients of the respective article (i.e., to third parties).

At 440, the at least one processor can reward one or more creators (i.e., arrangement creating end user(s) or modified arrangement creating end user(s)) of an article. Such may, for example, be in response to receipt of an order for the respective article, or for a modification or different version of the article which is based on the respective article. Rewards can include crediting an account with redeemable credits, providing free or subsidized merchandise, a prepaid debit or gift card. Preferably, the reward is a contribution to a charity or non-profit organization, particularly one selected by the creator of the article that generated the reward.

The method 400 terminates or ends at 442, for example, until called or invoked again. In some implementations, the method 400 can operate as a plurality of separate or distinct threads on one or more processors, and/or can continually operate while the processor(s) is operating.

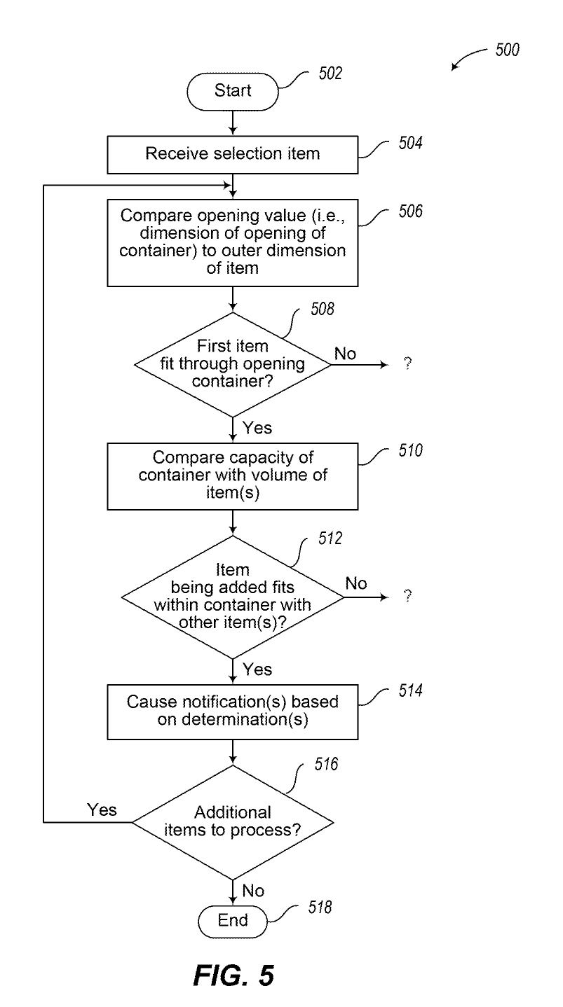

FIG. 5 shows a method 500 of operation in a system to generate customized orderable articles, according to at least one illustrated implementation. The system can comprise at least one processor and at least one processor-readable medium communicatively coupled to the at least one processor, and at least one communications port that provides communications, for example, with one or more end user processor-based devices.

The method 500 can be implemented for each of a plurality of articles which are each created by one or more end users, in many instances using a first instance of a first article as a basis or template to create a customized article, for example, by changing a container or contents (i.e., items) held by the container, and/or customizing a tag and/or storybook that accompanies, and is considered part of, the article.

Images and hyperlinks described herein can, for example, be presented as tiles, expanded tiles, and/or pop-up user interface elements with images, text, user-selectable icons and other user interface elements.

The method 500 starts at 502, for example, in response to a power up of the system, receipt of a Webpage request, or invocation of a calling routine.

At 504, at least one processor receives information that represents a selection indicative of an item of the two or more items. In a first iteration, the item may be denominated as a first item in the set of two or more items. For a second iteration the item may be denominated as a second item in the set of two or more items, and for a third iteration the item may be denominated as a third item, etc.

At 506, the at least one processor compares an opening value indicative of a defined dimension of an opening in the respective container to a value indicative of at least one defined outer dimension of the item.

At 508, the at least one processor determines whether the first item will fit through the opening in the respective container based on the comparison of the opening value and the at least one defined outer dimension of the item.

For example, in executing acts 506 and 508, the at least one processor compares at least one of: i) a radius of the opening in the first container to a width of the first item; or ii) an area of the opening in the first container to an area encompassed by a perimeter of the first item.

At 510, the at least one processor compares a capacity value indicative of a defined capacity of the container with a value indicative of a defined volume of one or more item(s). The at least one processor can thus, determine whether a newly selected item or addition to an already selected set of items will fit in the volume of the container given the volume that the already selected set of items will occupy.

At 512, the at least one processor determines whether the item being added will fit in the container based on the comparison of the capacity value indicative of the defined capacity of the container with the value indicative of the defined volume of the item(s).

For example, in executing acts 510 and 512, the at least one processor, compares a total number of items defined as being holdable by the container to a total number of items in the set of at least two items, and determines whether the total number of items in the set of at least two items is not greater than the total number of items defined as being holdable by the container.

Also for example, in executing acts 510 and 512, the at least one processor, compares a total defined sub-volumes defined as being holdable by the container to a total number of items in the set of at least two items, and determines whether the total number of items in the set of at least two items is not greater than the total number of sub-volumes defined as being holdable by the container.

As a further example, in executing acts 510 and 512, the at least one processor, the at least one processor determines a cumulative volume of the items in the set of at least two items, and compares a volume of the container to the determined cumulative volume of the items in the set of at least two items, and determines whether the cumulative volume of the items in the set of at least two items is not greater than the volume of the container.

At 514, the at least one processor causes at least one notification to be provided, via the at least one communications port, based on at least one of the determinations with respect to the item.

For example, in response to determining that an item will not fit through the opening in the respective container, the at least one processor provides or causes to be provided a notification that indicates that the respective item is too large to fit through the opening of the respective container. Additionally or alternatively, in response to determining that an item will not fit through the opening in the respective container, the at least one processor provides or causes to be provided a prompt to select an alternative to the respective item.

Additionally or alternatively, in response to determining that an item will not fit through the opening in the respective container, the at least one processor provides or causes to be provided a prompt to select an alternative to the first container. As a further example, in response to determining that an item will not fit through the opening in the respective container, the at least one processor can search for a larger container that is of a same type as the respective container. The at least one processor can provide or cause to be provided a prompt to the user with results from the search, which results can include user selectable icons or hyperlinks, selection of which can cause presentation of corresponding container tiles or select the container as a substitute for the respective container and update the article information accordingly.

As another example, the at least one processor may provide or cause to be provided a notification that indicates that the respective item is too large to fit within the respective container in response to determining that the cumulative volume of the first, the second and/or possibly other items is greater than the capacity value indicative of the defined capacity of the respective container.

As a further example, in response to determining that an item will not fit in the respective container, the at least one processor provides or causes to be provided a prompt to the user to select an alternative item to the item that will not fit. For instance, the at least one processor can search for a plurality of alternative items, to the respective item, that will both fit through the opening in the respective container and that will fit in the respective container along with the other items. For instance, the at least one processor can search for a plurality of alternative items that will fit through the opening in the first container and that will fit in the first container along with the first time. Searching for a plurality of alternative items to the respective item can include: determining at least one category in which the second item is classified or at least one key term associated with the second item, and identifying the alternative items that are classified in the at least category that is the same as the at least one category in which the second item is classified or that has at least one key term in common. The at least one processor can provide or cause to be provided a prompt with the plurality of alternative items to be provided to select one of the alternative items from the plurality of alternative items.

Additionally or alternatively, in response to determining that an item will not fit in the respective container, the at least one processor provides or causes to be provided a prompt to be provided to select an alternative to the respective container. The at least one processor can, for example, search for a larger container that is of a same type as the first container. The at least one processor, for example, prompts or causes a prompt with the plurality of alternative items to be provided to select one of the alternative items from the plurality of alternative items. The prompt can include user selectable icons (i.e., hyperlinks) for each of the alternative items, selection of which can display a corresponding item tile or even substitute the item for the item that will not fit.

Additionally or alternatively, in response to determining both: i) that the item will fit through the opening of the container, and ii) that the cumulative volume of the first, second and/or possibly other items is not greater than the capacity value indicative of the defined capacity of the respective container, the at least one processor provides or causes to be provided a notification that indicates that the respective item fits in the respective container.

At 516, the at least one processor determines if there are additional items to process. Thus, the at least one processor can repeat acts 504-514 for additional items, for example, a first, a second, a third or more items of the set of two or more items. The at least one processor can process through a list or set of item, or alternatively can be called or invoked on an item-by-item basis, for example, as items are added to an article during virtual creation of the article.

The method 500 ends at 518, for example, until invoked again. In some implementations, the method 500 can repeat continuously or periodically. In some implementations, the method 500 can execute as multiple instances, for example, as a thread or process of a multi-threaded process.

The method 500 can additionally or alternatively calculate and/or compare other values that are reflective of the ability to include a given item in a container, either alone or along with additional items.

COMPRESSIBILITY: In addition to the assessing dimensions for each item, for example based on metadata, the at least one processor can assess compressibility and take in to account compressibility when assessing the ability of an item to fit through an opening in a container or to fit within the container along with other items. For example, the dimensions of a bracelet may be 3 inches×3 inches×0.25 inches which would not fit into a 2 inch×2 inch×2 inch container. However, the compressibility metadata may indicate that the bracelet is 0.5 compressible. The at least one processor determines that the bracelet will indeed fit into the 2 inch×2 inch×2 inch container.

SURFACE AREA: In some situations, for instance articles comprising boxes, the at least one processor can assess container fit based on item surface area. For example, the at least one processor can calculate or retrieve a primary (e.g., label side) surface area of each item, and asses such to confirm whether each item can be beautifully displayed with the label side visible without overlap) in the selected container (e.g., box).

% FULL: The at least one processor can assess or determine, uniquely for every container, a % full that equals 100% full, and displays as such to the user. For example, when a jar is 60% filled, it may be set to display the jar as being 100% filled to the customer. Also for example, when a box is 75% full, the system may display the box as 100% filled to the customer.

SUGGEST A KNICK THAT WILL FIT: When a container is 80% full, the at least one processor can search for, identify and present additional items that could fit in the remaining 20% of the container's capacity. For example, the at least one processor determines the remaining or available volume of the container or the dimensions of the remaining or available volume of the container. The at least one processor can than search a dataset of items for items that are not larger than the volume or dimensions, for example taking into account compressibility of the items being searched as well as compressibility of the items already selected. The at least one processor can additionally take into account an existing theme when searching, for instance determining that currently selected products are all related to a particular theme or category (e.g., kitchen, spa products, sweets). The at least one processor can populate the results field with the results of the search.

FILL IT UP: When a user wants to fill up a remaining or available volume of the container, for example with candy such as gum balls, the at least one processor can identify how much room is left in the container, calculate the volume of candy required to fill it up remaining volume, and then calculate a cost/volume of the candy that will be added to “fill up” the container. This will be useful in two situations, for instance when a user wants to fill an empty container, or when a user wants to fill a container for which one or more items have already been selected, but the user wants to bury the items in candy, confetti, etc.

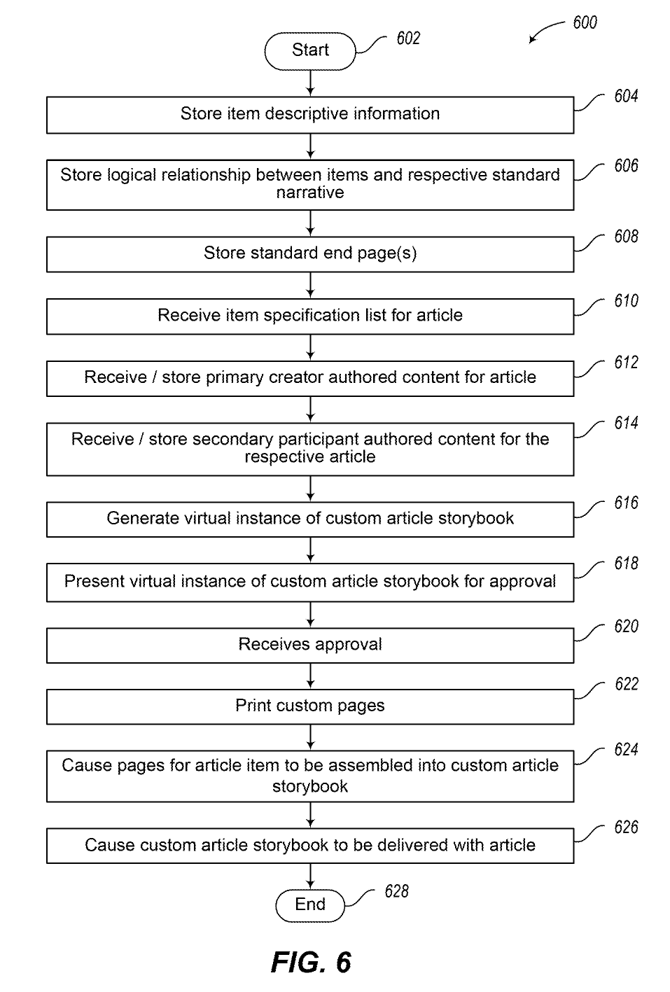

FIG. 6 shows a method 600 of operation in a system to generate customized orderable articles, according to at least one illustrated implementation. The system can comprise at least one processor and at least one processor-readable medium communicatively coupled to the at least one processor, and at least one communications port that provides communications, for example, with one or more end user processor-based devices.

The method 600 can be implemented for each of a plurality of articles which are each created by one or more end users, in many instances using a first instance of a first article as a base or template to create a customized article, for example, by changing a container or contents (i.e., items) held by the container, and/or customizing a tag and/or storybook that accompanies, and is considered part of, the article.

Images and hyperlinks described herein can, for example, be presented as tiles, expanded tiles, and/or pop-up user interface elements with images, text, user-selectable icons and other user interface elements. For example, at least one processor assigns a unique article instance identifier that uniquely identifies an instance of the respective article and/or a unique order identifier. The at least one processor logically associates a container and each of the items on the respective item specification list for the article via the respective unique article instance identifier or unique order identifier.

The method 600 starts at 602, for example, in response to a power up of the system, receipt of a Webpage request, or invocation of a calling routine.

At 604, for each of a plurality of items available for selection, at least one processor stores item descriptive information to the at least one nontransitory processor-readable medium. The item descriptive information includes a respective standard prose form narrative about the respective item. The standard prose form narrative can be supplied by a manufacturer or producer or distributor of the specific item, or can be supplied by an operator of the Web portal or Website on which articles including the items are or will be created. The standard prose form narrative can include a short description of the item, its construction, materials, uses, origin, special attributes or meanings. The at least one processor can store item descriptive information prior to creation of a particular article by one or more users.

At 606, for each of a plurality of items available for selection, at least one processor stores a logical relationship between the respective item and the respective standard prose form narrative about the respective item by the at least one nontransitory processor-readable medium. For example, at least one processor assigns a unique container identifier that uniquely identifies the container and/or a unique item identifier that uniquely identifies the item. The at least one processor can store container and/or item identifiers prior to creation of a particular article by one or more users. This allows the at least one processor to later retrieve the standard prose form narrative in response to a selection of the respective item by a user.

At 608, at least one processor stores or causes storage of one or more standard end pages by the at least one nontransitory processor-readable medium. The standard end page(s) can be standard over a large number of custom storybooks. The standard end page(s) can, for example, identify the Website or Web portal via which the custom article was created, and provide background information on the services, and information for accessing the services or making inquiries about the services or the specific custom article. The standard end page(s) is typically designed and/or specified by the operator or entity that provides the Website or Web portal. The at least one processor can store the standard end page(s) prior to creation of a particular article by one or more users. For each of a number of articles being created, at least one processor performs one or more of a series of acts (i.e., 610-626). The specific acts dependent on specific user selections or inputs. The total number of iterations is likewise dependent on specific user selections or inputs. Some implementations can omit some of the actions, include additional acts, and/or can perform the acts in a different order.

At 610, at least one processor receives a respective item specification list. The respective item specification list identifies a container and each of a plurality of items that are part of the respective article as created or defined by one or more end users.

At 612, at least one processor receives and stores a set of primary creator authored content for the respective article to the at least one nontransitory processor-readable medium. The set of primary creator authored content includes a customized prose form narrative provided by a primary end user or primary creator responsible for creation of the respective article. The customized prose form narrative is a principal tool in demonstrating the personal effort a creator has exerted in customizing the article for an intended recipient. The customized prose form narrative can be a personal message to an intended recipient, for example, including a greeting, a reason for the gift, an expression of thankfulness, appreciation or affection to or for the intended recipient. The customized prose form narrative can describe the article, the container, the and/or items. The customized prose form narrative can describe a relationship of the selected items to the intended recipient, for example, a relationship of the selected items to an interest, hobby, occupation, or fascination of the intended recipient. The customized prose form narrative can be entered as free-form text in a free-form text entry field of a Webpage or Web portal. The at least one processor can, for example, logically associate the respective set of primary creator authored content with the respective unique article instance identifier.

Optionally at 614, at least one processor receives and stores at least one set of secondary participant authored content for the respective article to the at least one nontransitory processor-readable medium. The set of secondary participant authored content includes a customized prose form narrative provided by one or more secondary creators or end users who participated in creation of the respective article, in contrast to the primary creator or end user who is in principally in charge of the project or article creation. This advantageously fosters group collaboration, allowing two or more secondary participants to customize the article by providing their own respective customized message to one created by a primary or principal end user.

Optionally at 616, at least one processor generates a virtual instance of the custom article storybook from stored standard information or pages (e.g., front cover, back cover, primary creator message page, secondary participant or creator message pages, itemization, container and item specific pages, back page). The at least one processor generates the virtual instance of the custom article storybook from stored standardized information or content, stored customized information or content (e.g., primary creator authored content, participant authored content), and based on the itemization information (e.g., container specification, items specification). For example, the at least one processor can generate virtual representations of a plurality of physical pages (e.g., front cover, salutation page, itemization, customized storybook pages based on primary author and secondary participant narratives, standard end page) for display to one or more users (e.g., primary creator, secondary participant or creator(s)).

Optionally at 618, at least one processor presents or causes presentation of a virtual instance of the custom article storybook for approval before causing the pages for the respective item to be assembled into the respective custom article storybook. For example, at least one processor can present or cause presentation of a virtual instance of the custom article storybook for approval to at least the primary creator or end user responsible for creation of the respective article, and optionally to one or more secondary participants or end users, via respective end user devices. The virtual instance of the custom article storybook can be ordered and formatted to accurately visually reflect the way a physical copy of the customized storybook will appear if accepted.

At 620, at least one processor receives approval from at least the primary end user responsible for creation of the respective article. In response, the at least one processor causes printing of custom pages at 622 for the custom article storybook.

At 624, at least one processor causes the pages for the respective article to be assembled into a custom article storybook. For example, at least one processor can generate control files and forward the control files to one or more hardware collators or collating machines to assembly various pieces of pre-printed and “on-demand” printed media. Alternatively, the processor(s) can place an order with a print shop.

At 626, at least one processor causes the custom article storybook to be delivered with the respective article. For example, at least one processor logically associates the custom article storybook with a respective order for a particular instance of an article. The order has delivery information logically associated therewith, which can include a delivery address, intended recipient name, and shipping date. The order can be uniquely identified via a unique order identifier. The custom article storybook can likewise be uniquely identified via a unique custom article storybook identifier. The custom article storybook can be logically associated to the order via a logical mapping between the unique order identifier and the unique custom article storybook identifier, which can be stored in a database or other data structure (e.g., field(s) of record(s)).

The method 600 ends at 628, for example, until invoked again. In some implementations, the method 600 can repeat continuously or periodically. In some implementations, the method 600 can execute as multiple instances, for example, as a thread or process of a multi-threaded process.

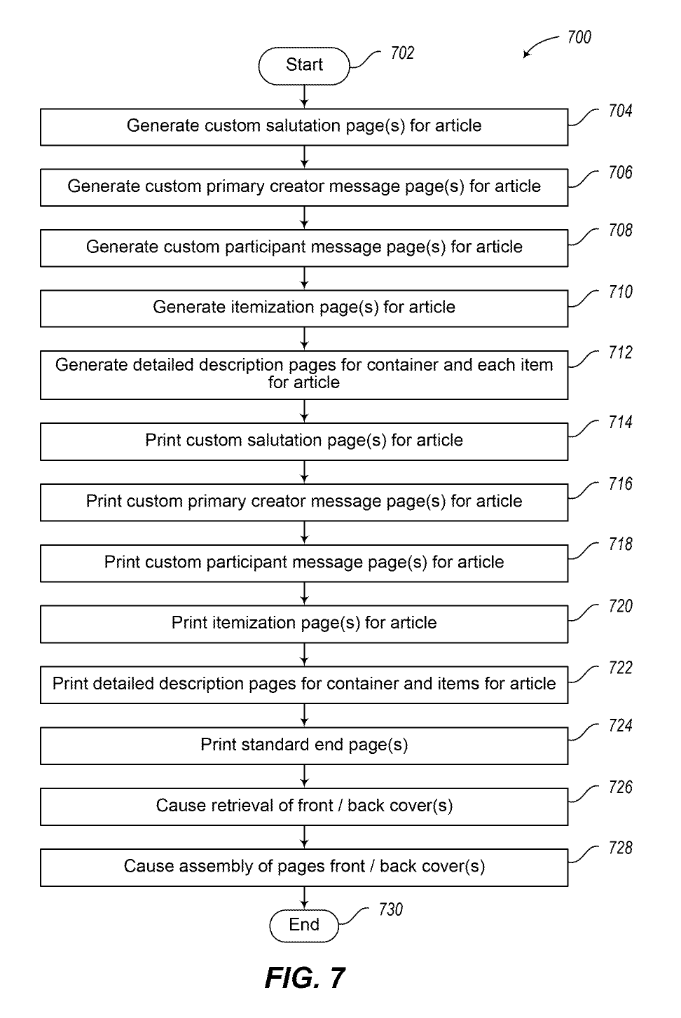

FIG. 7 shows a method 700 of operation in a system to generate customized orderable articles, according to at least one illustrated implementation. The method 700 can be implemented in conjunction with the method 600 (FIG. 6), for example, to perform one or more acts (e.g., 620) of the method 600 or in response to calls or invocations thereby. The method 700 can produce a customized storybook, which accompanies or is part of the article, to be sent to an intended recipient in a physical (e.g., hardcopy) form and, optionally in an additional virtual (e.g., software) form.

The method 700 starts at 702, for example, in response to a power up of the system, receipt of a Webpage request, or invocation of a calling routine.

For each of a number of articles being created, at least one processor performs one or more of a series of acts (i.e., 704-728). The specific acts are dependent on specific user selections or inputs. The total number of iterations is likewise dependent on specific user selections or inputs. Some implementations can omit some of the actions, include additional acts, and/or can perform the acts in a different order.

At 704, at least one processor generates at least one custom salutation page. The custom salutation page is typically the first customized page that an intended will see in a customized article storybook. The salutation page will typically include a short greeting or message, typically identifying the creator(s), intended recipient(s), and optionally occasion for the article or gift (e.g., “Thank you teacher, from your 5^{th} grade class”; “Happy Birthday John, from your bowling team”). The at least one processor can, for example, generate print information or a print file for the custom salutation page(s) which include the customized prose provided by one or more end users.

At 706, at least one processor generates at least one custom primary creator message page. The custom primary creator message page includes the customized prose form narrative provided by a primary end user responsible for creation of the respective article. The at least one processor can, for example, generate print information or a print file for the custom primary creator message page(s) which include the customized prose form narrative provided by one or more primary creators or end users.

At 708, at least one processor generates at least one custom participant message page for the respective article. The at least one custom participant message page includes the customized prose form narrative provided by one or more secondary creators or end users who participated in creation of the respective article (in contrast to the primary creator or end user) who is in principally in charge of the project or article creation. The at least one processor can, for example, generate print information or a print file for the custom participant message page(s) which include the customized prose form narrative provided by one or more secondary creators or end users.

At 710, at least one processor generates at least one itemization page. The itemization page includes a high level specification of the container and items in the respective article. For example, itemization page identifies a container and each of the items to be held by the container using a respective container or item name, a respective name of a collection to which they belong, and including a picture or other image of the container and items. The at least one itemization page can specify a quantity of each of the items in the respective article. The at least one processor can, for example, generate print information or a print file for the itemization page(s) which include the container and item information from information provided by one or more manufacturers, distributors or from the entity that operates the Website or Web portal.

At 712, at least one processor generates or causes generation of the detailed pages for the container and each of the items. The detailed container and the item description pages include the respective standard prose form narrative providing detailed information about the respective container or items. The at least one processor can, for example, logically associate the container and each of the items on the respective item specification list for the article with the respective unique article instance identifier. The container and each item can itself be identified with a unique identifier (e.g., unique container identifier, unique item identifier). The at least one processor can retrieve information or even pre-generated print files (i.e., stored before the creation of the respective article) from nontransitory storage media for the respective container and items based on logically association. While each of the information or print files for each container and/or article can be standard, the set of information or print files is custom to the particular article based on the specific container and set of items that comprise the particular article, as specified by the creator end user(s).

At 714, at least one processor prints or causes a printing of at least one custom salutation page for the respective article. For example, at least one processor can send a print file to a hardware printer or alternatively to a print shop for printing.

At 716, at least one processor prints or causes a printing of at least one custom primary creator message page. For example, at least one processor can send a print file to a hardware printer or alternatively to a print shop for printing.

At 718, at least one processor prints or causes a printing of at least one custom participant message page for the respective item to be printed. For example, at least one processor can send a print file to a hardware printer or alternatively to a print shop for printing.

At 720, at least one processor prints or causes a printing of at least one itemization page.

At 722, at least one processor prints or causes a printing of detailed description pages for the container and each of the items to be printed. For example, at least one processor can generate print files and forward the print files to one or more hardware printers via print drivers to be printed on respective pieces of media. Alternatively, the processor(s) can place a print order with a print shop.

Optionally at 724, at least one processor prints or causes a printing of a standard end page to be printed. The at least one processor can retrieve or cause retrieval of stored standard end page information or standard end page print files from at least one nontransitory processor-readable medium. The at least one processor can cause printing of standard end page from the standard end page information or standard end page print files. In some implementations, the standard end pages can be pre-printed (i.e., printed before the creation of the respective article). Pre-printing of various pieces of media allows quicker production of custom storybooks, can reduce costs, and can allow for the inclusion of graphics or color graphics, which might otherwise be more difficult if all media were printed on-demand.

At 726, at least one processor causes retrieval of at least one of a front cover or back cover. The front and/or back covers are preferable pre-printed (i.e., printed before the creation of the respective article). For example, in some implementations, the at least one processor can cause at least one collating machine to autonomously retrieve a standard preprinted cover folder. Alternatively, the at least one processor can provide a detailed specification sheet that specifies the various components and order for the components to be retrieved and physically assembled. The standard preprinted cover folder can have a first portion that comprises the front cover, and a second portion that comprises the back cover. The second portion can be separated or delineated from the first portion by a fold-line. The collating machine can form the fold-line in the pre-printed cover folder during assembly of the custom article storybook. Alternatively, the collating machine can retrieve preprinted cover folders from a supply of such, with the fold-lines already formed.

At 728, at least one processor causes assembly of the pages with at least one of the front cover and/or the back cover. For example, the at least one processor can cause one or more collating machines to autonomously insert standard and customized pages in a standard preprinted cover folder, between the first and the second portions thereof, in a defined order and/or orientation. The pages can, for example, include a custom salutation page, custom primary creator or participant message page, custom secondary creator participant message page(s), itemization that is customized to the article, set of container and item detailed description pages, the set customized to the article, and a standard end or closing page.

The method 700 ends at 730, for example, until invoked again. In some implementations, the method 700 can repeat continuously or periodically. In some implementations, the method 700 can execute as multiple instances, for example, as a thread or process of a multi-threaded process.

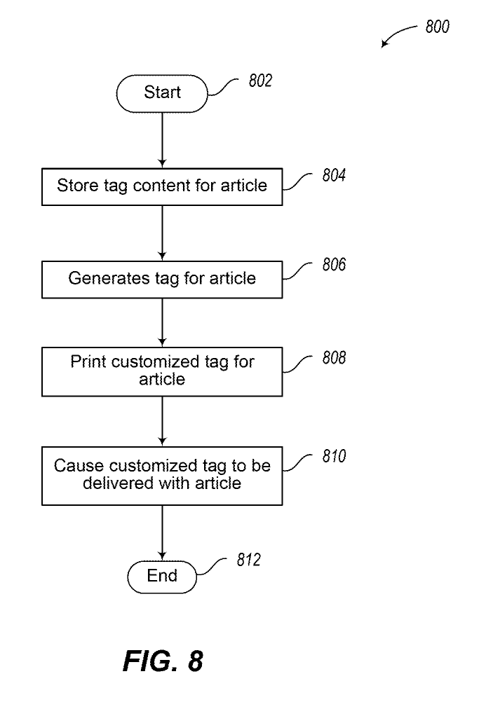

FIG. 8 shows a method 800 of operation in a system to generate customized orderable articles, according to at least one illustrated implementation. The method 800 can be implemented in conjunction with the method 600 (Figure). The method 800 can produce a customized tag, which accompanies or is part of the article, to be sent to an intended recipient in a physical (e.g., hardcopy) form and, optionally in an additional virtual (e.g., software) form.

The method 800 starts at 802, for example, in response to a power up of the system, receipt of a Webpage request, or invocation of a calling routine.

At 804, at least one processor stores a set of tag content for the respective article to the at least one nontransitory processor-readable medium. The at least one customized tag includes the at least one message, typically a short message. For example, the at least one processor stores at least one standard message portion and at least one custom message portion for each of at least some of the tags. The standard message portion is uniform across the plurality of articles, and can even be pre-printed (i.e., printed before the creation of the respective article). The custom message portion is supplied by at least one creator or end user that participated in creating the respective article. The at least one processor can cause the custom message portion to be printed on an otherwise pre-printed piece of tag media, which can include one or more pre-printed messages (e.g., Website or Web portal address) as well as graphics.

At 806, at least one processor generates at least one tag. For example, the at least one processor can generate print information or print files that specify printer-executable instructions for printing the custom tag.

At 808, at least one processor causes at least one customized tag to be printed. For example, at least one processor can generate print files and forward the print files to one or more hardware printers via print drivers to be printed on respective pieces of media. Alternatively, the processor(s) can place a print order with a print shop.

At 810, at least one processor causes the at least one tag to be delivered with the respective article. For example, at least one processor logically associates the custom tag with a respective order for a particular instance of an article. The order has delivery information logically associated therewith, which can include a delivery address, intended recipient name, and shipping date. The order can be uniquely identified via a unique order identifier, which can be used to automatically produce a shipping label consisting of intended recipient address information and possibly return address information. The custom tag can likewise be uniquely identified via a unique custom tag identifier. The custom tag can be logically associated to the order via a logical mapping between the unique order identifier and the unique custom tag identifier, which can be stored in a database or other data structure (e.g., field(s) of record(s)).

The method 800 ends at 812, for example, until invoked again. In some implementations, the method 800 can repeat continuously or periodically. In some implementations, the method 800 can execute as multiple instances, for example, as a thread or process of a multi-threaded process.

Populating an inventory of available items, can be performed manually. For example, manually searching, manually sourcing, and/or manually finding individual items. For instance, manual searching of Websites, calling vendors, attending trade shows, and browsing boutiques may all be employed to find items that customers can use to assemble a curated collection (i.e., Knacks) of articles. Additionally or alternatively, automated sourcing of items may be performed. For example a Web crawler may automatically search the Internet for suitable items. The Web crawler may continually search the Web for new items. New items that are found can be added to a catalog of available items. The catalog can, for example, include pricing, description, inventory levels, etc. Use of a Web crawler and catalog can reduce or even eliminate the need for manual data entry.

Once an item is sourced, a decision is may be made on how much inventory to stock, if the item is to be maintained in stock. Additionally, a digital copy of the item's information is made available to the public via an e-commerce site (e.g., Web portal, Website or Web services). The item's information may include, for example an item description, a price, pictures, etc.

In some implementations, inventory may not be held or limited inventory may be held by the entity that provides the Web portal, Website or Web services. For example, inventory may be distributed (e.g., held by a vendor of the item), rather than being held or inventoried by the entity that offers the collection of items. In at least some instances, a user can creates a curated collection (i.e. Knack) of items from virtually any item that is available via any retailer. This advantageously removes the need to stock items by entity that provides the Web portal, Website or Web services. As inventory becomes more distributed, the concept of fitting into a single container (e.g., jar, box) becomes less and less relevant.

Once a digital copy of an item is created, tags can be associated with the item. For example, tags can be manually created and/or associated with each of the items. Tags can represent characterizations of the times, for example at a more abstract level than a description of the items. Tags may include, for example: colors, occasions, seasons, product category, etc. The tags create a dynamic network among the items (i.e., an “item network”), which may be represented in one or more nontransitory computer- or processorr-readable media. This item network is independent of any single retailer in that the network includes at least some items offered and sold by a first retailer which are not offered and sold by a second retailer and also includes at least some items offered and sold by the second retailer which are not offered and sold by the first retailer. This can be true for a virtually unlimited number of retailers. While there is exclusivity for at least some items in the item network as between two retailers, such exclusivity may not exist for all available items in the item network. Thus, some additional items may be offered and sold by both the first and second retailers. The item network thus differs from groups of related items that might be presented by a single retailer.

The item network is then used to manually and/or automatically build collections of items, for example autonomously by a computer. Collections of items are also created by users who may, or may not consult or search via the tags, and who may associate other tags with an item or even create entirely new tags to be associated with one or more items.

Some implementations may employ natural language processing to automate the creation of the tags. This automates the creation of the “item network” described above. Automated creation or generation of tags can advantageously employ information from the catalog as well as information from the collections of items that users create.

In some instances, collections are manually built based on the tagging. These collections can be highly based on context, for instance based on one or more of demographic, geography, purpose, occasion, etc. To accomplish such, a processor-based device can reference the “item network” to create collections of items in real-time based on user needs and/or user context. For example, where a user is shopping around a defined date, the processor-based device may note a correlation to a calendar holiday (e.g., Christmas) or a birthday of the user, a relative of the user, or a friend of the user, and generate a collection composed of items suitable for the holiday or birthday and/or relative or friend. For example, where a user selects an item associated with a trip to a beach, the processor-based device may automatically generate a collection composed of beach related items. The processor-based device may rely on stored associations between users and other users or those who the user typically sends gifts. The collections of items are made available for purchase via the Web portal, Website or Web services. Once a user purchases a collection, a processor-based device generates a unique stock keeping unit (SKU) that defines or represents the unique collection of items. The SKU and collection of items are always associated with the user that created the respective collection of items. Such may, for example, allow rewarding or acknowledging of users that create popular collections of items.

When an order is placed, the user who places the order has the option to add additional tags to the corresponding SKU. A processor-based device feeds the added tags back into the “item network” to further enhance the network's knowledge of which items go together.

Once payment has been received, documentation is created about the collection. For example, a processor-based device may pull or retrieve appropriate documentation from the catalog. This documentation can be made available in print format and/or digital format. After the documentation has been created, a photograph of the new collection of items is taken. The photograph may, for example be manually captured via a camera and a photo booth, to create professional looking images of the collections of items.

Alternatively or additionally, one or more processor-based devices may automatically generate images of the collections of items. For example, the processor-based device(s) may obtain or retrieve images of individual items in a collection of items, for instance from the catalog. The processor-based device(s) determine various dimensions of the individual items, for example from dimensions listed in the catalog, or with the items on a Webpage, and/or based on apriori knowledge of dimensions of similar items. The processor-based device(s) employs the dimensions to scale the images of the individual items relative to one another to be in the correct proportions. For example, a close up image of one item may be scaled down, while a distant image of another item may be scaled up, and an image of a third item may remain unscaled. The processor-based device(s) can determine a scaling ratio that renders the relative size of the items in each of the images at least approximate (e.g., within 15%) the actual relative size or proportions of the items in the real world. The processor-based device(s) then combines the individual images to create or generate a combined images, with each of the items in the collection represented, preferably in relative scale to one another. In some instances, the combined image, or even the images of the individual items (e.g., scaled images, unscaled images) may be provided to a human to be arranged, rearranged or improved. One approach do doing so would be to publish requests via a crowd sourcing Website where individuals provide piecemeal services.

Once the SKU, the documentation, and image is generated or created, the processor-based device(s) can transmit the image and optionally the documentation to the user. The documentation and the collection of items are delivered to the user or recipient, for example via a courier.

After the order has been fully shipped, the new SKU can now be made available for re-purchase by the user or some other user. The item network may be automatically updated based on the new SKU. When the new SKU is purchased by some other user, the user that originally created the collection corresponding to the new SKU is rewarded. For example, a processor-based device can award points or a redeemable credit to the user that originally created the collection corresponding to the new SKU.

Thus, the system allows dynamic generation of new SKUs, and associated collections of items, images, and supporting documentation. As described, the dynamic generation of new SKUs may, for instance, be user generated SKUs. Also as described, the dynamic generation of new SKUs may, for instance, be SKUs autonomously generated by the system (e.g., processor-based device) for example based at least in part on one or more tags and/or based at least in part on context (e.g., information representing user or recipient demographics, geography, purpose, occasion, season, relationship, destination). The item network may be automatically updated based on new SKUs. Thus the item network may be, at least to some extent, customer or end user generated or updated. As previously noted, the item network spans multiple vendors or retailers, including some items offered by a first vendor/retailer that are not offered by a second vendor/retailer, and including other items offered by the second vendor/retailer that are not offered by the first vendor/retailer, although item exclusivity may not apply to all offered items.

In some instances a collection of items and associated SKU and processing of orders for the same may be associated with a specific container or dimensions. Yet in other instances the collection of items and associated SKU and orders for the same are not associated with any container. For example, the items comprising a given collection of items may be widely dispersed and fulfilled by respective vendors who may be geographically dispersed and who may have no formal business relationship with one another. An order for the given collection, for example as identified by a given SKU, can be distributed amongst a plurality of venders, and individually fulfilled by the various venders, each employing their own respective container (e.g., jar, box, crate, other packaging) for the respective item. A processor-based device can automatically parse an order for a given collection, as identified by a SKU, into individual orders, and automatically transmit the individual orders to various vendors who are capable of fulfilling the respective individual portion of the overall order. The processor-based device can automatically transmit appropriate information to the user (e.g., customer, recipient), for example an image of the given collection and/or documentation, either digitally and/or via a courier or postal mail.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other systems to generate customized orderable articles, not necessarily the exemplary server computing system generally described above.

The system provides ability to make gifts as well as make other collections of goods which may, or may not, be given as gifts. For example, the system and user interface could be used to custom make candles. To make a custom candle, the user selects a container from a plurality of containers, selects a type of wax from a plurality of wax types, selects a scent and/or a color from a palette of scents and/or colors. The user can optionally customize a product label and/or tag, which can be applied to the container. The resulting candle is custom created according to the user's own specifications, whether to be given as a gift or kept by the creating user. This system and user interface can applied to creation of an endless number of collections of products, e.g., custom created collections of spa products (e.g., bath salts), accessories (e.g., gloves, hats & scarfs), home décor and food products (e.g., custom truffles, nut betters, syrups, etc.).

In some implementations or instances, some containers may not be reusable, and may even not be decorative. For example, some articles can employ boxes as containers. Such boxes can be premium boxes, for instance lacquered boxes typically used in Japan or China, or alternatively cardboard boxes with or without imagery or other decorative affectations.

In some implementations, the tag can be omitted since users can already write their own personalized messages in the customized storybooks. In some implementations, the system generates a customized product label for the article, which can be applied to the customized article. The customized product label can be unique to the article, including the combination of container, items and/or storybook. For example, a user can create a custom product label for their customized candles.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including: U.S. provisional patent application Ser. No. 62/217,266 filed Sep. 11, 2015 and titled “INTERACTIVE GENERATION OF CUSTOMIZED ORDERABLE ARTICLES APPARATUS, METHODS, ARTICLES AND TOOLS” (Atty Docket No. 540083.401 P1); U.S. provisional patent application Ser. No. 62/217,273 filed Sep. 11, 2015 and titled “INTERACTIVE GENERATION OF CUSTOMIZED ORDERABLE ARTICLES APPARATUS, METHODS, ARTICLES AND TOOLS” (Atty Docket No. 540083.402P1); and U.S. provisional patent application Ser. No. 62/217,275 filed Sep. 11, 2015 and titled “INTERACTIVE GENERATION OF CUSTOMIZED ORDERABLE ARTICLES APPARATUS, METHODS, ARTICLES AND TOOLS” (Atty Docket No. 540083.403P1) are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation in a system to generate customized orderable articles, the system which comprises at least one processor and at least one processor-readable medium communicatively coupled to the at least one processor, and at least one communications port that provides communications, the method comprising:
for a first instance of a first article that comprises a first container and a first set of two or more items to be held by the first container,
receiving, by the at least one processor, information that represents a selection indicative of a first item of the two or more items;
comparing, by the at least one processor, an opening value indicative of a defined dimension of an opening in the first container to a value indicative of at least one defined outer dimension of the first item;
determining, by the at least one processor, whether the first item will fit through the opening in the first container based on the comparison of the opening value and the at least one defined outer dimension of the first item;
comparing, by the at least one processor, a capacity value indicative of a defined capacity of the first container with a value indicative of a defined volume of the first item;
determining, by the at least one processor, whether the first item will fit in the first container based on the comparison of the capacity value indicative of the defined capacity of the first container with the value indicative of the defined volume of the first item; and
causing at least one notification to be provided, via the at least one communications port, based on at least one of the determinations with respect to the first item.

2. The method of claim 1, further comprising:
for the first instance of the first article,
receiving, by the at least one processor, information that represents a selection indicative of a second item of the two or more items;
comparing, by the at least one processor, the opening value indicative of the defined dimension of the opening in the first container to a value indicative of at least one defined outer dimension of the second item;
determining, by the at least one processor, whether the second item will fit through the opening in the first container based on the comparison of the opening value and the at least one defined outer dimension of the second item;
comparing, by the at least one processor, the capacity value indicative of the defined capacity of the first container with a value indicative of a cumulative volume of the first and the second items;
determining, by the at least one processor, whether the second item will fit in the first container based on the comparison of the capacity value indicative of the defined capacity of the first container with the value indicative of the cumulative volume of the first and second items; and
causing at least one notification to be provided via the at least one communications port based on at least one of the determinations with respect to the second item.

3. The method of claim 2, further comprising:
for the first instance of the first article,
receiving, by the at least one processor, information that represents a selection indicative of a third item of the two or more items;
comparing, by the at least one processor, the opening value indicative of the defined dimension of the opening in the first container to a value indicative of at least one defined outer dimension of the third item;
determining, by the at least one processor, whether the third item will fit through the opening in the first container based on the comparison of the opening value and the at least one defined outer dimension of the third;
comparing, by the at least one processor, the capacity value indicative of the defined capacity of the first container with a value indicative of a cumulative volume of the first, the second, and the third items;
determining, by the at least one processor, whether the second item will fit in the first container based on the comparison of the capacity value indicative of the defined capacity of the first container with the value indicative of the cumulative volume of the first, the second, and the third items; and
causing at least one notification to be provided via the at least one communications port based on at least one of the determinations with respect to the third item.

4. (canceled)

5. The method of claim 2 wherein comparing the capacity value indicative of the defined capacity of the first container with a value indicative of a cumulative volume of the first and the second items includes comparing a total defined sub-volumes defined as being holdable by the container to a total number of items in the set of at least two items, and wherein determining whether the second item will fit in the first container based on the comparison of the capacity value indicative of the defined capacity of the first container with the value indicative of the cumulative volume of the first and second items includes determining whether the total number of items in the set of at least two items is not greater than the total number of sub-volumes defined as being holdable by the container.

6. The method of claim 2 wherein comparing the capacity value indicative of the defined capacity of the first container with a value indicative of a cumulative volume of the first and the second items includes: determining a cumulative volume of the items in the set of at least two items, and comparing a volume of the container to the determined cumulative volume of the items in the set of at least two items, and wherein determining whether the second item will fit in the first container includes determining whether the cumulative volume of the items in the set of at least two items is not greater than the volume of the container.

7. The method of claim 2 wherein causing at least one notification to be provided based on at least one of the determinations with respect to the second item includes providing a notification that indicates that the second item is too large to fit through the opening of the first container in response to determining that the second item will not fit through the opening in the first container.

8. The method of claim 2 wherein causing at least one notification to be provided based on at least one of the determinations with respect to the second item includes providing a notification that indicates that the second item is too large to fit within the first container in response to determining that the cumulative volume of the first and second items is greater than the capacity value indicative of the defined capacity of the first container.

9.-11. (canceled)

12. The method of claim 2, further comprising:
in response to determining that the second item will not fit through the opening in the first container, autonomously searching by the system for a larger container that is of a same type as the first container; and
causing a prompting of the user with a result from the searching.

13. (canceled)

14. The method of claim 2, further comprising:
in response to determining that the second item will not fit through the opening in the first container,
searching, by the at least one processor, for a plurality of alternative items, to the second item, that will fit through the opening in the first container and that will fit in the first container along with the first item; and
causing a prompt with the plurality of alternative items to be provided to select one of the alternative items from the plurality of alternative items.

15. The method of claim 14 wherein searching for a plurality of alternative items to the second item includes: determining at least one category in which the second item is classified or at least one key term associated with the second item, and identifying the alternative items that are classified in the at least category that is the same as the at least one category in which the second item is classified or that has at least one key term in common.

16. (canceled)

17. The method of claim 2, further comprising:
in response to determining that the second item will not fit in the first container, autonomously searching by the system for a larger container that is of a same type as the first container.

18. The method of claim 2, further comprising:
in response to determining that the second item will not fit in the first container,
autonomously searching, by the at least one processor, for a plurality of alternative items, to the second item, that will fit through the opening in the first container and that will fit in the first container along with the first item; and
causing a prompt with the plurality of alternative items to be provided to select one of the alternative items from the plurality of alternative items.

19. The method of claim 18 wherein searching for a plurality of alternative items to the second item includes: determining at least one category in which the second item is classified or at least one key term associated with the second item, and identifying the alternative items that are classified in the at least category that is the same as the at least one category in which the second item is classified or that has at least one key term in common.

20. (canceled)

21. The method of claim 1 wherein causing at least one notification to be provided based on at least one of the determinations with respect to the first item includes providing a notification that indicates that the first item is too large to fit through the opening of the first container in response to determining that the first item will not fit through the opening in the first container.

22. The method of claim 1 wherein causing at least one notification to be provided based on at least one of the determinations with respect to the first item includes providing a notification that indicates that the first item is too large to fit within the first container in response to determining that the first item will not fit in the first container.

23. (canceled)

24. A system to generate customized orderable articles, comprising:
at least one processor;
at least one communications port that provides communications between the customized article generation system and a plurality of remotely located devices;
at least one processor-readable medium communicatively coupled to the at least one processor, and which stores at least one of processor-readable instructions or data, which when executed by the at least one processor, cause the at least one processor to:
for a first instance of a first article that comprises a first container and a first set of two or more items held by the first container,
receive information that represents a selection indicative of a first item of the two or more items;
compare an opening value indicative of a defined dimension of an opening in the first container to a value indicative of at least one defined outer dimension of the first item;
determine whether the first item will fit through the opening in the first container based on the comparison of the opening value and the at least one defined outer dimension of the first item;
compare a capacity value indicative of a defined capacity of the first container with a value indicative of a defined volume of the first item;
determine whether the first item will fit in the first container based on the comparison of the capacity value indicative of the defined capacity of the first container with the value indicative of the defined volume of the first item; and
cause at least one notification to be provided based on at least one of the determinations with respect to the first item.

25. The system of claim 24 wherein the at least one of processor-readable instructions or data, when executed by the at least one processor, further cause the at least one processor to:
for the first instance of the first article,
receive information that represents a selection indicative of a second item of the two or more items;
compare the opening value indicative of the defined dimension of the opening in the first container to a value indicative of at least one defined outer dimension of the second item;
determine whether the second item will fit through the opening in the first container based on the comparison of the opening value and the at least one defined outer dimension of the second item;
compare the capacity value indicative of the defined capacity of the first container with a value indicative of a cumulative volume of the first and the second items;
determine whether the second item will fit in the first container based on the comparison of the capacity value indicative of the defined capacity of the first container with the value indicative of the cumulative volume of the first and second items; and
cause at least one notification to be provided based on at least one of the determinations with respect to the second item.

26. The system of claim 25 wherein the at least one of processor-readable instructions or data, when executed by the at least one processor, further cause the at least one processor to:
for the first instance of the first article,
receive information that represents a selection indicative of a third item of the two or more items;
compare the opening value indicative of the defined dimension of the opening in the first container to a value indicative of at least one defined outer dimension of the third item;
determine whether the third item will fit through the opening in the first container based on the comparison of the opening value and the at least one defined outer dimension of the third;
compare the capacity value indicative of the defined capacity of the first container with a value indicative of a cumulative volume of the first, the second, and the third items;
determine whether the second item will fit in the first container based on the comparison of the capacity value indicative of the defined capacity of the first container with the value indicative of the cumulative volume of the first, the second, and the third items; and
cause at least one notification to be provided based on at least one of the determinations with respect to the third item.

27.-33. (canceled)

34. The system of claim 25 wherein the at least one of processor-readable instructions or data, when executed by the at least one processor, further cause the at least one processor to:
in response to determining that the second item will not fit through the opening in the first container, autonomously search for a larger container that is of a same type as the first container; and
cause a prompt to the user with a result from the search.

35. (canceled)

36. The system of claim 25 wherein the at least one of processor-readable instructions or data, when executed by the at least one processor, further cause the at least one processor to:
in response to determining that the second item will not fit through the opening in the first container,
autonomously search for a plurality of alternative items, to the second item, that will fit through the opening in the first container and that will fit in the first container along with the first item; and
cause a prompt with the plurality of alternative items to be provided to select one of the alternative items from the plurality of alternative items.

37. The system of claim 36 wherein the at least one of processor-readable instructions or data, when executed by the at least one processor, further cause the at least one processor to:
determine at least one category in which the second item is classified or at least one key term associated with the second item, and identify the alternative items that are classified in the at least category that is the same as the at least one category in which the second item is classified or that has at least one key term in common.

38. (canceled)

39. The system of claim 25 wherein the at least one of processor-readable instructions or data, when executed by the at least one processor, further cause the at least one processor to:
in response to determining that the second item will not fit in the first container, autonomously search for a larger container that is of a same type as the first container.

40. The system of claim 25 wherein the at least one of processor-readable instructions or data, when executed by the at least one processor, further cause the at least one processor to:
in response to determining that the second item will not fit in the first container,
autonomously search for a plurality of alternative items, to the second item, that will fit through the opening in the first container and that will fit in the first container along with the first item; and
cause a prompt with the plurality of alternative items to be provided to select one of the alternative items from the plurality of alternative items.
